(19) United States
(12) Patent Application Publication
(10) Pub. No.: US 2026/0022278 A1
(43) Pub. Date: Jan. 22, 2026

(54) ADHESIVE COMPOSITION, ADHESIVE SHEET, ADHESIVE SHEET WITH RELEASE FILM, LAMINATE FOR IMAGE DISPLAY DEVICE, IMAGE DISPLAY DEVICE, AND ADHESIVE SHEET FOR ORGANIC EL DISPLAY DEVICE

(71) Applicant: MITSUBISHI CHEMICAL CORPORATION, Tokyo (JP)

(72) Inventors: Hisatoshi KURA, Tokyo (JP); Daiki NOZAWA, Tokyo (JP)

(73) Assignee: MITSUBISHI CHEMICAL CORPORATION, Tokyo (JP)

(21) Appl. No.: 19/340,729

(22) Filed: Sep. 25, 2025

Related U.S. Application Data
(63) Continuation of application No. PCT/JP2024/006782, filed on Feb. 26, 2024.

(30) Foreign Application Priority Data
Mar. 27, 2023 (JP) 2023-049998

(51) Int. Cl. C09J 7/38; B32B 7/06; B32B 27/30; C09J 5/00

(52) U.S. Cl. CPC C09J 7/385; B32B 7/06; B32B 27/308; C09J 5/00; B32B 2405/00; B32B 2457/20; C09J 2203/326; C09J 2301/414; C09J 2301/416

(57) ABSTRACT

An adhesive composition is used for bonding an optical member, the adhesive composition containing a (meth)acrylic polymer (A) and a photoinitiator (B), in which the photoinitiator (B) contains a photoinitiator (b1).

### CROSS-REFERENCE TO RELATED APPLICATIONS

This application is a continuation application of International Application No. PCT/JP2024/006782, filed on Feb. 26, 2024, which claims the benefit of priority of the prior Japanese Patent Application No. 2023-049998, filed Mar. 27, 2023, the content of which is incorporated herein by reference.

### TECHNICAL FIELD

The present disclosure relates to an adhesive composition, an adhesive sheet using the same, an adhesive sheet with a release film, a laminate for an image display device, an image display device, and an adhesive sheet for an organic Electroluminescent (EL) display device.

### BACKGROUND ART

In recent years, in order to improve visibility of image display devices, a void between an image display panel, such as a liquid crystal display (LCD), a plasma display panel (PDP), and an electroluminescent display (ELD) and an optical member such as a protective panel and a touch panel member, which is disposed on a front surface side (visible side) of the image display panel and filled with a resin, such as an adhesive, and reflection of incident light or emitted light from a display image at an air layer interface is suppressed.

For example, Patent Document 1 discloses a method of irradiating an adhesive sheet with ultraviolet rays to perform secondary curing after bonding an adhesive sheet which has been subjected to primary crosslinking with ultraviolet rays to an image display device constituent member as a manufacturing method of a constituent laminate for an image display device, which has a configuration in which the image display device constituent member is laminated on at least one side of the transparent double-sided adhesive sheet.

In addition, Patent Document 2 discloses an adhesive sheet containing a (meth)acrylic copolymer having an ultraviolet crosslinkable moiety as an adhesive sheet useful for a display and a touch panel.

### CITATION LIST

### Patent Documents

Patent Document 1: Japanese Patent No. 4971529

Patent Document 2: Japanese Patent No. 6062740

### SUMMARY

### Technical Problem

Most of the adhesive sheets which form a crosslinked structure upon ultraviolet irradiation contain a photoinitiator, which generates a radical upon ultraviolet irradiation. However, in recent years, from the viewpoint of energy saving and member protection, there has been an increasing demand for an adhesive sheet which is photocured with relatively low energy and high efficiency, that is, an adhesive sheet which is cured by energy rays on a relatively long wavelength side (for example, active energy rays having a wavelength longer than 380 nm), particularly visible rays.

Furthermore, in recent years, with the demand for power saving, weight reduction, and thinning of image display devices, organic EL has been widely used as an image display panel instead of the liquid crystal panel in the related art.

In an image display device such as an organic EL display device, a constituent member or the like in the image display device may be deteriorated by ultraviolet rays, and an adhesive sheet which is cured by visible light is strongly required in order to suppress deterioration due to the ultraviolet rays.

In addition, in an adhesive sheet which is bonded to an adherend such as the image display device constituent member and is secondary-cured by irradiating the adhesive sheet with light through the member, when an intervening member has ultraviolet absorbability, there is a problem in that light required for the curing does not reach the adhesive sheet, and the adhesive sheet used in the image display device having such a configuration needs to be an adhesive sheet which is cured with visible light.

Therefore, a photocurable adhesive sheet using a photoinitiator having absorption in a long wavelength ultraviolet range or a visible light range, or an α-aminoacetophenone-based photoinitiator or acylphosphine oxide-based photoinitiator has been developed. However, these cleavage-type photoinitiators generate outgas, such as benzaldehyde, as a photodecomposition product, which is not preferable from the viewpoint of the environment.

On the other hand, in hydrogen abstraction-type photoinitiators, such as a thioxanthone-based photoinitiator and an anthraquinone-based photoinitiator, which does not generate the photodecomposition product, although the photoinitiator has absorption in the long wavelength ultraviolet range or the visible light range, the photoinitiator has poor hydrogen abstraction ability and cannot obtain sufficient curing sensitivity as compared with photoinitiators such as benzophenone-based photoinitiators, which do not have absorption in a long wavelength range.

An object of the present disclosure is to provide an adhesive composition for bonding an optical member, which is curable with an energy ray on a relatively long wavelength side (for example, an active energy ray having a wavelength of longer than 380 nm, in particular, an active energy ray of 405 nm) and has a small amount of photodecomposition products; an adhesive sheet for bonding an optical member; and an adhesive sheet with a release film, a laminate for an image display device, an image display device, and an adhesive sheet for an organic EL display device, each of which uses the adhesive sheet.

### Solution to Problem

One embodiment of the present disclosure includes the following aspects.

[1] An adhesive composition used for bonding an optical member, the adhesive composition comprising:
a (meth)acrylic polymer (A); and
a photoinitiator (B),
in which the photoinitiator (B) contains a photoinitiator (b1), which is a compound having, in a molecule, a radically polymerizable functional group having a carbon-carbon double bond and a radical generating group and has a molar absorption coefficient of 30 (L/mol·cm) or more at 405 nm.

[2] The adhesive composition according to [1],
in which the photoinitiator (b1) includes at least one selected from the group consisting of a hydrogen abstraction-type photoinitiator having a structure in which the radical generating group is excited by irradiation with an active energy ray to generate a radical through a hydrogen abstraction reaction and an intramolecular cleavage-type photoinitiator which generates a radical by the excitation of the radical generating group by the irradiation with an active energy ray and subsequent cleavage in the molecule.

[3] The adhesive composition according to [1] or [2],
in which the photoinitiator (b1) is a hydrogen abstraction-type photoinitiator in which the radically polymerizable functional group is a (meth)acryloyl group, the hydrogen abstraction-type photoinitiator having a structure in which the radical generating group is excited by irradiation with an active energy ray to generate a radical through a hydrogen abstraction reaction.

[4] The adhesive composition according to any one of [1] to [3],
in which the radical generating group in the photoinitiator (b1) has at least one structure selected from the group consisting of a benzoin structure, a benzyl ketal structure, an acylphosphine oxide structure, an α-aminoacetophenone structure, an α-hydroxyacetophenone structure, a benzophenone structure, a thioxanthone structure, an anthraquinone structure, a phenylglyoxylate structure, and an oxime ester structure.

[5] The adhesive composition according to any one of [1] to [4],
in which the radical generating group in the photoinitiator (b1) has a thioxanthone structure.

[6] The adhesive composition according to any one of [1] to [5],
in which a contained amount of the photoinitiator (B) is 0.01 parts by mass or more with respect to 100 parts by mass of the (meth)acrylic polymer (A).

[7] The adhesive composition according to any one of [1] to [6],
in which a contained amount of the photoinitiator (b1) in the photoinitiator (B) is 30% by mass or more with respect to a total mass of the photoinitiator (B).

[8] The adhesive composition according to any one of [1] to [7],
in which the (meth)acrylic polymer (A) includes a structural unit derived from an alkyl (meth)acrylate (m1) having a linear or branched alkyl group having 3 to 30 carbon atoms in an alkyl group and at least one structural unit of a structural unit derived from a hydroxyl group-containing monomer (a2) or a structural unit derived from a nitrogen-containing monomer (a3).

[9] An adhesive sheet comprising:
an adhesive layer formed of the adhesive composition according to any one of [1] to [8].

[10] The adhesive sheet according to [9],
in which a gel fraction (X0) is 20% or more.

[11] The adhesive sheet according to [9] or [10],
in which the adhesive sheet has active energy ray curability, and a gel fraction (X1) of the adhesive sheet when the adhesive sheet is irradiated with an active energy ray having a wavelength of 405 nm with an irradiation amount within an integrated light amount of 2,000 to 4,000 mJ/cm2 is 30% or more.

[12] The adhesive sheet according to any one of [9] to [11],
in which a difference (X1-X0) between the gel fraction (X1) and the gel fraction (X0) is 10% or more.

[13] The adhesive sheet according to any one of [9] to [12],
in which the adhesive sheet is used for bonding an optical member.

[14] An adhesive sheet with a release film, comprising:
the adhesive sheet according to any one of [9] to [13]; and
a release film which is laminated with the adhesive sheet.

[15] A laminate for an image display device, comprising:
two optical members which are laminated through the adhesive sheet according to any one of [9] to [13].

[16] An image display device comprising:
the laminate for an image display device according to [15].

[17] An adhesive sheet for an organic EL display device, comprising:
the adhesive sheet according to any one of [9] to [13].

### Advantageous Effects

The adhesive composition according to the aspect of the present disclosure can be suitably used in an adhesive sheet for bonding an optical member, particularly, an adhesive sheet for an organic EL display device, in which the adhesive composition with a small amount of photodecomposition products can be cured with an energy ray on a relatively long wavelength side (for example, an energy ray having a wavelength of longer than 380 nm, in particular, an active energy ray of 405 nm).

### DESCRIPTION OF EMBODIMENTS

Hereinafter, an example of an embodiment of the present disclosure will be described in detail. However, the present disclosure is not limited to the embodiment described below.

In the present disclosure, a term “film” conceptually includes a sheet, a film, and a tape.

In addition, when expressed as a “panel,” such as an image display panel and a protective panel, the panel includes a plate body, a sheet, and a film.

In the present disclosure, when described as “x to y” (x and y are any numbers), unless otherwise specified, the description includes the meaning of “x or more and y or less” and also includes the meaning of “preferably more than x” or “preferably less than y.”

In addition, when described as “x or more” (x is any number), unless otherwise specified, the description includes the meaning of “preferably more than x”; and when described as “y or less” (y is any number), unless otherwise specified, the description includes the meaning of “preferably less than y.”

Furthermore, “x and/or y (x and y are optional configurations)” means at least one of x or y, and means three cases of only x, only y, and x and y.

In addition, in the present disclosure, “(meth)acrylic” means a concept including acrylic and methacrylic, “(meth)acrylate” means a concept including acrylate and methacrylate, and “(meth)acryloyl” means a concept including acryloyl and methacryloyl.

“(Meth)acrylic polymer” means a copolymer having a constitutional unit derived from a (meth)acrylic monomer. The (meth)acrylic polymer may further have a constitutional unit derived from a monomer other than the (meth)acrylic monomer (for example, styrene or the like).

### «Adhesive Composition»

The adhesive composition for bonding an optical member according to the embodiment of the present disclosure (hereinafter, referred to as “present adhesive composition”) contains a (meth)acrylic polymer (A) and a photoinitiator, (B) in which the photoinitiator (B) contains a photoinitiator (b1) which is a compound having, in a molecule, a radically polymerizable functional group having a carbon-carbon double bond and a radical generating group and has a molar absorption coefficient of 30 (L/mol·cm) or more at 405 nm.

Hereinafter, each component contained in the present adhesive composition will be described in detail.

### <(Meth)acrylic Polymer (A)>

Examples of the (meth)acrylic polymer (A) contained in the present adhesive composition include a homopolymer of an alkyl (meth)acrylate and a copolymer obtained by polymerizing a monomer component which is copolymerizable with the homopolymer.

Among these, it is preferable that the (meth)acrylic polymer includes two or more copolymerizable components, and at least one of the copolymerizable components is an alkyl (meth)acrylate having 3 to 30 carbon atoms in an alkyl group.

More specifically, examples of the above-described (meth)acrylic polymer (A) include a copolymer of monomer components, including the alkyl (meth)acrylate having 3 to 30 carbon atoms in an alkyl group and any one or more monomers copolymerizable with the alkyl (meth)acrylate, the monomers selected from (a1) a carboxy group-containing monomer other than the alkyl (meth)acrylate, (a2) a hydroxyl group-containing monomer, (a3) a nitrogen-containing monomer, (a4) an epoxy group-containing monomer, (a5) a vinyl monomer, (a6) an alkyl (meth)acrylate monomer having 1 or 2 carbon atoms in an alkyl group, (a7) an alicyclic monomer, and (a8) other copolymerizable monomers.

(1) Among the above-described copolymerizable monomers (a1) to (a8), the following copolymerizable monomer (a1), (a2), or (a3) is particularly preferable.

(2) In addition, it is particularly preferable that the above-described copolymerizable monomer (a1) is not included, and any of the copolymerizable monomer (a2) or (a3) is included; when any of the copolymerizable monomer (a2) or

(a3) is included, it is possible to achieve both anticorrosion properties, adhesiveness, and moisture-heat whitening resistance when an adherend contains a component having corrosiveness, such as metal. In addition, from the viewpoint of improving cohesive property, it is particularly preferable to include both the copolymerizable monomer (a2) and the copolymerizable monomer (a3).

(3) Among the copolymerizable monomers (a3), a copolymerizable monomer (a3) having a tertiary nitrogen atom is preferable from the viewpoint that a sensitizing action of a hydrogen abstraction reaction described later is provided, and as a result, crosslinking can be efficiently formed.

(4) Among the above-described alkyl (meth)acrylates, an alkyl (meth)acrylate containing a tertiary carbon atom in the alkyl group is preferable; by using such an alkyl (meth)acrylate, the hydrogen abstraction reaction is likely to occur during light irradiation, and as a result, crosslinking is likely to be efficiently formed.

The above-described alkyl (meth)acrylate is preferably a linear or branched alkyl (meth)acrylate having 3 to 30 carbon atoms in an alkyl group, and is represented by Formula (m1) (hereinafter, also referred to as a polymerizable monomer (ml)).

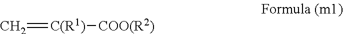

(in Formula (m1), R¹ represents a hydrogen atom or a methyl group, and R² represents a linear or branched alkyl group having 3 to 30 carbon atoms)

Examples of the alkyl (meth)acrylate represented by Formula (m1) include linear alkyl (meth)acrylates such as n-propyl (meth)acrylate, i-propyl (meth)acrylate, n-butyl (meth)acrylate, n-pentyl (meth)acrylate, n-hexyl (meth)acrylate, n-heptyl (meth)acrylate, n-octyl (meth)acrylate, n-nonyl (meth)acrylate, n-decyl (meth)acrylate, undecyl (meth)acrylate, lauryl (meth)acrylate, n-tridecyl (meth)acrylate, n-tetradecyl (meth)acrylate, cetyl (meth)acrylate, stearyl (meth)acrylate, icosyl (meth)acrylate, henicosyl (meth)acrylate, and behenyl (meth)acrylate; and branched alkyl (meth)acrylates such as sec-butyl (meth)acrylate, isobutyl (meth)acrylate, tert-butyl (meth)acrylate, isopentyl (meth)acrylate, neopentyl (meth)acrylate, 2-ethylhexyl (meth)acrylate, isooctyl (meth)acrylate, isononyl (meth)acrylate, isodecyl (meth)acrylate, isostearyl (meth)acrylate, isoicosyl (meth)acrylate, butyloctyl (meth)acrylate, isomyristyl (meth)acrylate, isocetyl (meth)acrylate, hexyldecyl (meth)acrylate, isostearyl (meth)acrylate, octyldecyl (meth)acrylate, octyldodecyl (meth)acrylate, and isobehenyl (meth)acrylate. These may be used alone or in combination of two or more kinds thereof.

Among the above, a linear alkyl (meth)acrylate is preferable from the viewpoint of obtaining flexibility. In addition, from the viewpoint of balancing adhesiveness and flexibility, an alkyl (meth)acrylate having, in an alkyl group, 3 to 20 carbon atoms, more preferably 5 to 18 carbon atoms, particularly preferably 6 to 16 carbon atoms, and most preferably 7 to 14 carbon atoms is preferable. For example, n-butyl (meth)acrylate, n-pentyl (meth)acrylate, n-hexyl (meth)acrylate, n-octyl (meth)acrylate, n-nonyl (meth)acrylate, decyl (meth)acrylate, or lauryl (meth)acrylate is preferable.

In addition, among the above, from the viewpoint that a hydrogen abstraction reaction described later is likely to occur during light irradiation, and as a result, a crosslinked structure can be efficiently formed, a branched alkyl (meth)acrylate is preferably used, and among these, a branched alkyl (meth)acrylate having, in an alkyl group, 3 to 20 carbon atoms, more preferably 5 to 18 carbon atoms, particularly preferably 6 to 16 carbon atoms, and most preferably 7 to 14 carbon atoms is preferable. For example, sec-butyl (meth)acrylate, isobutyl (meth)acrylate, tert-butyl (meth)acrylate, isopentyl (meth)acrylate, neopentyl (meth)acrylate, 2-ethylhexyl (meth)acrylate, isooctyl (meth)acrylate, isononyl (meth)acrylate, or isodecyl (meth)acrylate is preferable.

A proportion of the constitutional unit derived from the above-described alkyl (meth)acrylate to 100% by mass of all constitutional units constituting the (meth)acrylic polymer (A) is preferably 5% by mass or more and 95% by mass or less, more preferably 10% by mass or more and 90% by mass or less, still more preferably 15% by mass or more and 85% by mass or less, and particularly preferably 20% by mass or more and 80% by mass or less. When the proportion of the constitutional unit derived from the alkyl (meth)acrylate is equal to or more than the above-described lower limit value, the flexibility tends to be excellent, and unevenness followability when the adherend has unevenness tends to be excellent. When the proportion of the constitutional unit derived from the alkyl (meth)acrylate is equal to or less than the above-described upper limit value, an effect of the copolymerizable monomer described later is easily obtained, and the adhesive composition tends to have excellent adhesive force and cohesive force. The lower limit and upper limit of the contained amount of the constitutional unit derived from the above-described alkyl (meth)acrylate can be arbitrarily combined.

Examples of the above-described carboxy group-containing monomer (a1) include (meth)acrylic acid, 2-(meth)acryloyloxyethyl hexahydrophthalate, 2-(meth)acryloyloxypropyl hexahydrophthalate, 2-(meth)acryloyloxyethyl phthalate, 2-(meth)acryloyloxypropyl phthalate, 2-(meth)acryloyloxyethyl maleate, 2-(meth)acryloyloxypropyl maleate, 2-(meth)acryloyloxyethyl succinate, 2-(meth)acryloyloxypropyl succinate, crotonic acid, fumaric acid, maleic acid, and itaconic acid. These may be used alone or in combination of two or more kinds thereof.

Examples of the above-described hydroxyl group-containing monomer (a2) include hydroxyalkyl (meth)acrylates such as 2-hydroxyethyl (meth)acrylate, 4-hydroxybutyl (meth)acrylate, 5-hydroxypentyl (meth)acrylate, 6-hydroxyhexyl (meth)acrylate, and 8-hydroxyoctyl (meth)acrylate; caprolactone-modified hydroxy (meth)acrylates such as caprolactone-modified 2-hydroxyethyl (meth)acrylate; (meth)acrylates having an oxyalkylene structure, such as diethylene glycol (meth)acrylate, polyethylene glycol (meth)acrylate, polypropylene glycol (meth)acrylate, polytrimethylene glycol (meth)acrylate, and polyoxyethylene-polyoxypropylene glycol (meth)acrylate; primary hydroxyl group-containing (meth)acrylates such as 2-acryloyloxyethyl-2-hydroxyethyl phthalate; secondary hydroxyl group-containing (meth)acrylates such as 2-hydroxypropyl (meth)acrylate, 2-hydroxybutyl (meth)acrylate, and 3-chloro-2-hydroxypropyl (meth)acrylate; tertiary hydroxyl group-containing (meth)acrylates such as 2,2-dimethyl 2-hydroxyethyl (meth)acrylate; and vinyl ethers such as 2-hydroxyethyl vinyl ether, diethylene glycol monovinyl ether, and 4-hydroxybutyl vinyl ether. These can be used alone or in combination of two or more kinds thereof.

The adhesive sheet can be improved in adhesive force and can suppress moisture-heat whitening by the hydroxyl group-containing monomer (a2). In addition, when the present adhesive composition contains a thermal crosslinking agent described later, the hydroxyl group-containing monomer (a2) is a reaction point for crosslinking.

Among the above-described hydroxyl group-containing monomers (a2), a hydroxyl group-containing monomer having, in a hydroxyalkyl group, 1 to 10 carbon atoms, more preferably 1 to 6 carbon atoms, and particularly preferably 2 to 4 carbon atoms is preferable. For example, 2-hydroxyethyl (meth)acrylate, 4-hydroxybutyl (meth)acrylate, 2-hydroxypropyl (meth)acrylate, 2-hydroxyethyl vinyl ether, diethylene glycol monovinyl ether, or 4-hydroxybutyl vinyl ether is preferable; and a primary hydroxyl group-containing (meth)acrylate, for example, 2-hydroxyethyl (meth)acrylate or 4-hydroxybutyl (meth)acrylate, is particularly preferable.

From the viewpoint of imparting adhesive force and moisture-heat whitening resistance, a contained amount of the constitutional unit derived from the above-described hydroxyl group-containing monomer (a2) in the (meth)acrylic polymer (A) is preferably 3% to 30% by mass, more preferably 5% to 25% by mass, and particularly preferably 7% to 20% by mass with respect to all constitutional units of the (meth)acrylic polymer (A).

Examples of the above-described nitrogen-containing monomer (a3) include amino group-containing monomers, amide group-containing monomers, isocyanate group-containing monomers, and (meth)acrylonitrile. The adhesive sheet can be improved in cohesive force and can suppress moisture-heat whitening by the nitrogen-containing monomer (a3). These may be used alone or in combination of two or more kinds thereof. In addition, the nitrogen-containing monomer (a3) has an action of promoting a hydrogen abstraction reaction described later.

Examples of the above-described amino group-containing monomer as the above-described nitrogen-containing monomer include primary amino group-containing (meth)acrylates such as aminomethyl (meth)acrylate and aminoethyl (meth)acrylate; secondary amino group-containing (meth)acrylates such as tert-butylaminoethyl (meth)acrylate and tert-butylaminopropyl (meth)acrylate; tertiary amino group-containing (meth)acrylates such as ethylaminoethyl (meth)acrylate, dimethylaminoethyl (meth)acrylate, diethylaminoethyl (meth)acrylate, dimethylaminopropyl (meth)acrylate, diethylaminopropyl (meth)acrylate, and dimethylaminopropyl acrylamide; and monomers such as N-vinylpyrrolidone, methylvinylpyrrolidone, vinylpyridine, vinylpiperidone, vinylpyrimidine, vinylpiperazine, vinylpyrazine, vinylpyrrole, vinylimidazole, vinyloxazole, vinylmorpholine, (meth)acryloylmorpholine, N-vinylacetamides, and N-vinylcaprolactam.

Examples of the above-described amide group-containing monomer include (meth)acrylamide; N-alkyl (meth)acrylamides such as N-methyl (meth)acrylamide, N-ethyl (meth)acrylamide, N-propyl (meth)acrylamide, N-n-butyl (meth)acrylamide, diacetone (meth)acrylamide, and N,N′-methylene bis (meth)acrylamide; N,N-dialkyl (meth)acrylamides such as N,N-dimethyl (meth)acrylamide, N,N-diethyl (meth)acrylamide, N,N-dipropyl (meth)acrylamide, N,N-ethylmethyl acrylamide, and N,N-diallyl (meth)acrylamide; hydroxyalkyl (meth)acrylamides such as N-hydroxymethyl (meth)acrylamide and N-hydroxyethyl (meth)acrylamide; alkoxyalkyl (meth)acrylamides such as N-methoxymethyl (meth)acrylamide and N-(n-butoxymethyl) (meth)acrylamide; and maleimide or a derivative thereof.

Examples of the above-described isocyanate group-containing monomer include 2-(meth)acryloyloxyethyl isocyanate and an alkylene oxide adduct thereof. The isocyanate group may be protected with a blocking agent such as methyl ethyl ketone oxime, 3,5-dimethylpyrazole, 1,2,4-triazole, and diethyl malonate.

Among the above, from the viewpoint of having a sensitizing action of a hydrogen abstraction reaction described later and thus being capable of efficiently forming a crosslinked structure, a monomer having a tertiary nitrogen atom is preferable;

and for example, a tertiary amino group-containing (meth)acrylate, N,N-dialkyl (meth)acrylamide, N-vinylpyrrolidone, or acryloylmorpholine is particularly preferable. From the viewpoint of imparting cohesive force and moisture-heat whitening resistance, a contained amount of the constitutional unit derived from the above-described nitrogen-containing monomer (a3) in the (meth)acrylic polymer (A) is preferably 0.1% to 15% by mass, more preferably 0.5% to 13% by mass, particularly preferably 1% to 10% by mass, and most preferably 2% to 7% by mass with respect to all constitutional units of the (meth)acrylic polymer (A).

Examples of the above-described epoxy group-containing monomer (a4) include glycidyl (meth)acrylate, methylglycidyl (meth)acrylate, 3,4-epoxycyclohexylmethyl (meth)acrylate, and 4-hydroxybutyl (meth)acrylate glycidyl ether. These may be used alone or in combination of two or more kinds thereof.

Examples of the above-described vinyl monomer (a5) include a compound having a vinyl group in the molecule. Examples of such a compound include vinyl ester monomers such as vinyl acetate, vinyl propionate, vinyl laurate, and vinyl stearate; and aromatic vinyl monomers such as styrene, chlorostyrene, chloromethylstyrene, α-methylstyrene, and other substituted styrenes. These may be used alone or in combination of two or more kinds thereof. These can be used alone or in combination of two or more kinds thereof.

Examples of the above-described alkyl (meth)acrylate monomer (a6) having 1 or 2 carbon atoms in an alkyl group include methyl (meth)acrylate and ethyl (meth)acrylate.

These may be used alone or in combination of two or more kinds thereof. From the viewpoint of imparting cohesive force to the adhesive sheet, a contained amount of the constitutional unit derived from the copolymerizable monomer (a6) in the (meth)acrylic polymer (A) is preferably 0.1% to 15% by mass, more preferably 0.5% to 13% by mass, particularly preferably 1% to 10% by mass, and most preferably 2% to 7% by mass with respect to all constitutional units of the (meth)acrylic polymer (A).

Examples of the above-described alicyclic monomer (a7) include cyclohexyl (meth)acrylate, 3,3,5-trimethylcyclohexyl (meth)acrylate, isobornyl (meth)acrylate, dicyclopentanyl (meth)acrylate, dicyclopentenyloxyethyl (meth)acrylate, tert-butylcyclohexyl (meth)acrylate, and adamantyl (meth)acrylate. These may be used alone or in combination of two or more kinds thereof.

From the viewpoint of imparting cohesive force to the adhesive sheet, a contained amount of the constitutional unit derived from the copolymerizable monomer (a7) in the (meth)acrylic polymer (A) is preferably 0.1% to 15% by mass, more preferably 0.5% to 13% by mass, particularly preferably 1% to 10% by mass, and most preferably 2% to 7% by mass with respect to all constitutional units of the (meth)acrylic polymer (A).

Examples of the above-described other copolymerizable monomer (a8) include (meth)acrylates having an alkoxyalkylene glycol skeleton, such as methoxydiethylene glycol (meth)acrylate, methoxypolyethylene glycol (meth)acrylate, butoxypolyethylene glycol (meth)acrylate, methoxypolypropylene glycol (meth)acrylate, butoxypolypropylene glycol (meth)acrylate, methoxypolytetramethylene glycol (meth)acrylate, butoxypolytetramethylene glycol (meth)acrylate, methoxypolyoxyethylene polyoxypropylene glycol (meth)acrylate, and butoxypolyoxyethylene polyoxypropylene glycol (meth)acrylate; aromatic (meth)acrylates such as phenyl (meth)acrylate, benzyl (meth)acrylate, phenoxyethyl (meth)acrylate, phenyldiethylene glycol (meth)acrylate, phenoxypolyethylene glycol (meth)acrylate, phenoxypolyethylene glycol-polypropylene glycol-(meth)acrylate, and nonylphenol ethylene oxide adduct (meth)acrylate; (meth)acrylates having a benzophenone structure, such as 4-acryloyloxybenzophenone, 4-acryloyloxyethoxybenzophenone, 4-acryloyloxy-4′-methoxybenzophenone, 4-acryloyloxyethoxy-4′-methoxybenzophenone, 4-acryloyloxy-4′-bromobenzophenone, 4-acryloyloxyethoxy-4′-bromobenzophenone, 4-methacryloyloxybenzophenone, 4-methacryloyloxyethoxybenzophenone, 4-methacryloyloxy-4′-methoxybenzophenone, 4-methacryloyloxyethoxy-4′-methoxybenzophenone, 4-methacryloyloxy-4′-bromobenzophenone, 4-methacryloyloxyethoxy-4′-bromobenzophenone, and a mixture thereof; heterocycle-containing (meth)acrylates such as tetrahydrofurfuryl (meth)acrylate; and macromonomers. These can be used alone or in combination of two or more kinds thereof.

A contained amount of the constitutional unit derived from the copolymerizable monomer (a8) in the (meth)acrylic polymer (A) is preferably 1% by mass or more and 30% by mass or less, more preferably 3% by mass or more and 20% by mass or less, and still more preferably 5% by mass or more and 15% by mass or less with respect to all constitutional units constituting the (meth)acrylic polymer (A). The above-described lower limit and upper limit of the above-described contained amount can be arbitrarily combined.

The (meth)acrylic polymer (A) may have a photoactive site, for example, a polymerizable carbon-carbon double bond group introduced into a side chain. In this manner, a crosslinking efficiency of the present adhesive composition can be increased, and the present adhesive composition can be crosslinked in a shorter time, thereby improving productivity.

Examples of a method of introducing the polymerizable carbon-carbon double bond group into the side chain of the (meth)acrylic polymer (A) include a method of preparing a copolymer containing the above-described hydroxyl group-containing monomer (a2) or the above-described functional group-containing ethylenically unsaturated monomer and condensing or addition-reacting a compound having a functional group capable of reacting with these functional groups and having a polymerizable carbon-carbon double bond group while maintaining the activity of the polymerizable carbon-carbon double bond group.

Examples of a combination of these functional groups include an epoxy group (glycidyl group) and a carboxy group, an amino group and a carboxy group, an amino group and an isocyanate group, an epoxy group (glycidyl group) and an amino group, a hydroxyl group and an epoxy group, and a hydroxyl group and an isocyanate group.

Among the combinations of these functional groups, a combination of a hydroxyl group and an isocyanate group is preferable from the viewpoint of ease of reaction control. Among the above, a combination in which the copolymer has a hydroxyl group and the compound has an isocyanate group is preferable.

Examples of the isocyanate compound having a polymerizable carbon-carbon double bond group include 2-(meth)acryloyloxyethyl isocyanate and an alkylene oxide adduct thereof described above.

From the viewpoint of improving adhesiveness and stress relaxing properties, a contained amount of the compound having the functional group which can react with the functional groups and the polymerizable carbon-carbon double bond group is preferably 10 parts by mass or less, more preferably 5 parts by mass or less, still more preferably 1 part by mass or less, and particularly preferably 0.1 parts by mass or less with respect to 100 parts by mass of the (meth)acrylic polymer (A). The lower limit value thereof is usually 0 parts by mass. Specifically, the contained amount of the above-described compound is preferably 0 parts by mass or more and 10 parts by mass or less, more preferably 0 parts by mass or more and 5 parts by mass or less, still more preferably 0 parts by mass or more and 1 part by mass or less, and particularly preferably 0 parts by mass or more and 0.1 parts by mass or less with respect to 100 parts by mass of the (meth)acrylic polymer (A).

From the viewpoint of obtaining the present adhesive composition having high cohesive force, a weight-average molecular weight (Mw) of the (meth)acrylic polymer (A) is preferably 200,000 or more, more preferably 300,000 or more, and still more preferably 400,000 or more.

In addition, from the viewpoint of handleability and uniform stirring property, the upper limit value of the weight-average molecular weight (Mw) of the (meth)acrylic polymer (A) is preferably 1,500,000 or less, more preferably 1,200,000 or less, still more preferably 1,100,000 or less, and particularly preferably 1,000,000 or less. Specifically, the weight-average molecular weight (Mw) of the (meth)acrylic polymer (A) is preferably 200,000 or more and 1,500,000 or less, more preferably 300,000 or more and 1,200,000 or less, still more preferably 400,000 or more and 1,100,000 or less, and most preferably 400,000 or more and 1,000,000 or less.

The lower limit and the upper limit of the weight-average molecular weight of the (meth)acrylic polymer (A) can be arbitrarily combined. The weight-average molecular weight of the (meth)acrylic polymer (A) is a value in terms of standard polystyrene, which is measured by gel permeation chromatography (GPC).

A production method of the (meth)acrylic polymer (A) is not particularly limited. For example, a method of polymerizing a monomer mixture including an alkyl (meth)acrylate having 3 to 30 carbon atoms in an alkyl group and one or more selected from the copolymerizable monomers (a1) to (a8) used as necessary can be used.

### <Photoinitiator (B)>

The present adhesive composition contains, as the photoinitiator (B), a photoinitiator (b1) which is a compound having, in a molecule, a radically polymerizable functional group having a carbon-carbon double bond and a radical generating group and has a molar absorption coefficient of 30 (L/mol·cm) or more at 405 nm. Here, the “radical generating group” means a group which generates a radical to initiate a polymerization reaction under excitation with active energy ray.

The photoinitiator is a compound which generates a radical by active energy ray. The photoinitiator is broadly classified into two types, based on a radical generation mechanism. More specifically, the photoinitiator is broadly classified into a cleavage-type photoinitiator, which can generate a radical by cleaving a single bond of the initiator itself, and a hydrogen abstraction-type photoinitiator, which can generate a radical by abstracting hydrogen from a hydrogen donor in the system by an excited initiator.

As the photoinitiator having high photosensitivity to light in a long wavelength range, α-aminoacetophenone-based or acylphosphine oxide-based photoinitiators have been mainly used. However, since these photoinitiators are a cleavage-type photoinitiator, outgas such as benzaldehyde is generated as a photodecomposition product, and thus improvement has been strongly desired.

In addition, hydrogen abstraction-type photoinitiators such as thioxanthone and anthraquinone, which have been known in the related art as photoinitiators having photosensitivity to light in a long wavelength range, do not generate the photodecomposition product, but have poor hydrogen abstraction ability and thus cannot obtain sufficient curing sensitivity as compared with photoinitiators such as benzophenone-based photoinitiators, which do not have absorption in a long wavelength range, and thus the use thereof has been limited.

Under such circumstances, the present inventors have conducted intensive studies, and as a result, they have found that, by using the photoinitiator (b1), which is a compound having, in a molecule, a radically polymerizable functional group having a carbon-carbon double bond and a radical generating group and has a molar absorption coefficient of 30 (L/mol·cm) or more at 405 nm, a curing reaction of the (meth)acrylic polymer (A) proceeds satisfactorily while suppressing generation of decomposition products, and the (meth)acrylic polymer (A) is cured by energy rays on a long wavelength side, for example, energy rays having a wavelength of 405 nm, thereby completing the present disclosure.

The photoinitiator (b1) has the radically polymerizable functional group having a carbon-carbon double bond in the molecule. By having such a structure, the photoinitiator is incorporated into the polymerized structure after the photoreaction, and the generation of decomposition products derived from the photoinitiator can be suppressed. In addition, bleeding out of the photoinitiator can be suppressed, and a cohesive force of the adhesive sheet can be improved, which is preferable.

Examples of the radically polymerizable functional group of the photoinitiator (b1) include a (meth)acryloyl group and an allyl group. Among the above, from the viewpoint of high reactivity, a (meth)acryloyl group is preferable, and an acryloyl group is more preferable.

The number of the radically polymerizable functional groups in the photoinitiator (b1) may be one or two or more, but is preferably one.

In addition, the photoinitiator (b1) has the radical generating group in the molecule. In this manner, the composition is activated by irradiation with active energy rays to generate a radical, and the radicals can be used as a starting point of the curing reaction.

As the radical generating group, a group derived from a known photoradical generator can be used. Examples thereof include a group having a structure which undergoes photolysis upon irradiation with active energy rays, such as an acylphosphine oxide structure, an α-aminoacetophenone structure, and an α-hydroxyacetophenone structure, a group having a structure which is excited by irradiation with active energy rays and generates a radical through a hydrogen abstraction reaction, such as a benzophenone structure, a thioxanthone structure, an anthraquinone structure, and a phenylglyoxylate structure, and a group having an oxime ester structure. Among the above, from the viewpoint of suppressing the generation of decomposition products, a structure which is excited by irradiation with active energy rays and causes a hydrogen abstraction reaction is preferable; and among these, from the viewpoint of adjusting the molar absorption coefficient at 405 nm, which will be described later, a group having a thioxanthone structure is particularly preferable.

By having a group having a hydrogen abstraction structure as the radical generating group, the photoinitiator (b1) functions as a hydrogen abstraction-type photoinitiator.

In a general hydrogen abstraction-type photoinitiator having a benzophenone structure, a thioxanthone structure, an anthraquinone structure, a phenylglyoxylate structure, or the like, an efficiency of hydrogen abstraction from a hydrogen donor is low in light in a long wavelength range, and thus the curing reaction of the (meth)acrylic polymer (A) is not likely to proceed. However, it is found that by using a photoinitiator which has a radically polymerizable functional group having a carbon-carbon double bond in the molecule together with the above-described hydrogen abstraction structure as the radical generating group and having a molar absorption coefficient of 30 (L/mol·cm) or more at 405 nm, surprisingly, the curing reaction of the (meth)acrylic polymer (A) proceeds satisfactorily, and the (meth)acrylic polymer (A) is cured by an energy ray on a long wavelength side, for example, an energy ray having a wavelength of 405 nm.

The hydrogen abstraction-type photoinitiator is preferable from the viewpoint that the photodecomposition product is not generated as in the cleavage-type photoinitiator. In addition, the hydrogen abstraction-type photoinitiator is also preferable from the viewpoint that the (meth)acrylic polymer (A) is also subjected to the hydrogen abstraction reaction, and the (meth)acrylic polymer (A) is incorporated into the crosslinked structure, whereby a crosslinked structure having many crosslinking points is easily formed.

The photoinitiator having the radically polymerizable functional group having a carbon-carbon double bond in the molecule is preferable from the viewpoint that, during the photocuring reaction, the photoinitiator is bonded to the carbon-carbon double bond of the (meth)acrylic polymer (A) or the polyfunctional (meth)acrylate (C) and is incorporated into the crosslinked structure and from the viewpoint that the photoinitiator can be prevented from bleeding out or migrating.

In the photoinitiator (b1), the molar absorption coefficient at 405 nm is 30 (L/mol·cm) or more, whereby sensitivity to long-wavelength active energy rays is excellent. Therefore, with the photoinitiator (b1), it is possible to obtain the present adhesive composition which can be cured by active energy rays having a relatively long wavelength (for example, active energy rays having a wavelength of 405 nm, which is longer than 380 nm). From such a viewpoint, the above-described molar absorption coefficient is preferably 40 (L/mol·cm) or more, more preferably 50 (L/mol·cm) or more, still more preferably 60 (L/mol·cm) or more, and particularly preferably 70 (L/mol·cm) or more.

From the viewpoint of internal (or deep) curability, the upper limit of the above-described molar absorption coefficient is preferably 1.0×10⁶ (L/mol·cm) or less, more preferably 5.0×10⁵ (L/mol·cm) or less, still more preferably 1.0×10⁵ (L/mol·cm) or less, and particularly preferably 5.0×10⁴ (L/mol·cm) or less.

The above-described lower limit and upper limit of the above-described molar absorption coefficient can be arbitrarily combined. Specifically, the above-described molar absorption coefficient is preferably 40 (L/mol·cm) or more and 1.0×10⁶ (L/mol·cm) or less, more preferably 50 (L/mol·cm) or more and 5.0×10⁵ (L/mol·cm) or less, still more preferably 60(L/mol·cm) or more and 1.0×10⁵ (L/mol·cm) or less, and particularly preferably 70 (L/mol·cm) or more and 5.0×10⁴ (L/mol·cm) or less.

The molar absorption coefficient of the photoinitiator (b1) at 405 nm is obtained by dissolving the photoinitiator (b1) at a predetermined concentration in chloroform or the like, measuring an absorbance at 405 nm using an ultraviolet-visible spectrophotometer, and calculating from the obtained absorbance according to the following expression.

$$A = ε L c$$

(A represents an absorbance, ¿ represents a molar absorption coefficient (L/mol·cm), c represents a molar concentration (mol/L) of the photoinitiator (b1), and L represents an optical path length (cm))

Specific examples of the photoinitiator (b1) include 1-(meth)acryloyloxythioxanthone, 2-(meth)acryloyloxythioxanthone, 3-(meth)acryloyloxythioxanthone, 4-(meth)acryloyloxythioxanthone, 1-(2-(meth)acryloyloxyethoxy)thioxanthone, 2-(2-(meth)acryloyloxyethoxy)thioxanthone, 3-(2-(meth)acryloyloxyethoxy)thioxanthone, 4-(2-(meth)acryloyloxyethoxy)thioxanthone, 1-(3-(meth)acryloyloxypropoxy)thioxanthone, 2-(3-(meth)acryloyloxypropoxy)thioxanthone, 3-(3-(meth)acryloyloxypropoxy)thioxanthone, 4-(3-(meth)acryloyloxypropoxy)thioxanthone, 1-(4-(meth)acryloyloxybutoxy)thioxanthone, 2-(4-(meth)acryloyloxybutoxy)thioxanthone, 3-(4-(meth)acryloyloxybutoxy)thioxanthone, 4-(4-(meth)acryloyloxybutoxy)thioxanthone, thioxanthone-1-carboxylic acid 2-(2-(meth)acryloyloxyethoxy)-2-oxoethyl ester, thioxanthone-2-carboxylic acid 2-(2-(meth)acryloyloxyethoxy)-2-oxoethyl ester, thioxanthone-3-carboxylic acid 2-(2-(meth)acryloyloxyethoxy)-2-oxoethyl ester, thioxanthone-4-carboxylic acid 2-(2-(meth)acryloyloxyethoxy)-2-oxoethyl ester, thioxanthone-1-carboxylic acid 2-(3-(meth)acryloyloxypropoxy)-2-oxoethyl ester, thioxanthone-2-carboxylic acid 2-(3-(meth)acryloyloxypropoxy)-2-oxoethyl ester, thioxanthone-3-carboxylic acid 2-(3-(meth)acryloyloxypropoxy)-2-oxoethyl ester, thioxanthone-4-carboxylic acid 2-(3-(meth)acryloyloxypropyloxy)-2-oxoethyl ester, thioxanthone-1-carboxylic acid 2-(4-(meth)acryloyloxybutoxy)-2-oxoethyl ester, thioxanthone-2-carboxylic acid 2-(4-(meth)acryloyloxybutoxy)-2-oxoethyl ester, thioxanthone-3-carboxylic acid 2-(4-(meth)acryloyloxybutoxy)-2-oxoethyl ester, thioxanthone-4-carboxylic acid 2-(4-(meth)acryloyloxybutoxy)-2-oxoethyl ester, thioxanthone-1-carboxylic acid 2-hydroxy-3-(2-(meth)acryloyloxyethoxy)propyl ester, thioxanthone-2-carboxylic acid 2-hydroxy-3-(2-(meth)acryloyloxyethoxy)propyl ester, thioxanthone-3-carboxylic acid 2-hydroxy-3-(2-(meth)acryloyloxyethoxy)propyl ester, thioxanthone-4-carboxylic acid 2-hydroxy-3-(2-(meth)acryloyloxyethoxy)propyl ester, thioxanthone-1-carboxylic acid 2-hydroxy-3-(3-(meth)acryloyloxypropoxy)propyl ester, thioxanthone-2-carboxylic acid 2-hydroxy-3-(3-(meth)acryloyloxypropoxy)propyl ester, thioxanthone-3-carboxylic acid 2-hydroxy-3-(3-(meth)acryloyloxypropoxy)propyl ester, thioxanthone-4-carboxylic acid 2-hydroxy-3-(3-(meth)acryloyloxypropoxy)propyl ester, thioxanthone-1-carboxylic acid 2-hydroxy-3-(4-(meth)acryloyloxybutoxy)propyl ester, thioxanthone-2-carboxylic acid 2-hydroxy-3-(4-(meth)acryloyloxybutoxy)propyl ester, thioxanthone-3-carboxylic acid 2-hydroxy-3-(4-(meth)acryloyloxybutoxy)propyl ester, thioxanthone-4-carboxylic acid 2-hydroxy-3-(4-(meth)acryloyloxybutoxy)propyl ester, 1-(2-hydroxy-3-(meth)acryloyloxypropoxy) thioxanthone, 2-(2-hydroxy-3-(meth)acryloyloxypropoxy)thioxanthone, 3-(2-hydroxy-3-(meth)acryloyloxypropoxy)thioxanthone, 4-(2-hydroxy-3-(meth)acryloyloxypropoxy)thioxanthone, thioxanthone-1-carboxylic acid 2-hydroxy-3-(meth)acryloyloxypropyl ester, thioxanthone-2-carboxylic acid 2-hydroxy-3-(meth)acryloyloxypropyl ester, thioxanthone-3-carboxylic acid 2-hydroxy-3-(meth)acryloyloxypropyl ester, thioxanthone-4-carboxylic acid 2-hydroxy-3-(meth)acryloyloxypropyl ester, thioxanthone-1-carboxylic acid 2-(meth)acryloyloxyethyl ester, thioxanthone-2-carboxylic acid 2-(meth)acryloyloxyethyl ester, thioxanthone-3-carboxylic acid 2-(meth)acryloyloxyethyl ester, thioxanthone-4-carboxylic acid 2-(meth)acryloyloxyethyl ester, thioxanthone-1-carboxylic acid 3-(meth)acryloyloxypropyl ester, thioxanthone-2-carboxylic acid 3-(meth)acryloyloxypropyl ester, thioxanthone-3-carboxylic acid 3-(meth)acryloyloxypropyl ester, thioxanthone-4-carboxylic acid 3-(meth)acryloyloxypropyl ester, thioxanthone-1-carboxylic acid 4-(meth)acryloyloxybutyl ester, thioxanthone-2-carboxylic acid 4-(meth)acryloyloxybutyl ester, thioxanthone-3-carboxylic acid 4-(meth)acryloyloxybutyl ester, thioxanthone-4-carboxylic acid 4-(meth)acryloyloxybutyl ester, 1-(3-(meth)acryloyloxy-1-oxopropoxy) thioxanthone, 2-(3-(meth)acryloyloxy-1-oxopropoxy)thioxanthone, 3-(3-(meth)acryloyloxy-1-oxopropoxy)thioxanthone, 4-(3-(meth)acryloyloxy-1-oxopropoxy) thioxanthone, 1-(4-(meth)acryloyloxy-1-oxobutoxy)thioxanthone, 2-(4-(meth)acryloyloxy-1-oxobutoxy)thioxanthone, 3-(4-(meth)acryloyloxy-1-oxobutoxy) thioxanthone, 4-(4-(meth)acryloyloxy-1-oxobutoxy)thioxanthone, 1-(5-(meth)acryloyloxy-1-oxopentoxy)thioxanthone, 2-(5-(meth)acryloyloxy-1-oxopentoxy)thioxanthone, 3-(5-(meth)acryloyloxy-1-oxopentoxy) thioxanthone, 4-(5-(meth)acryloyloxy-1-oxopentoxy)thioxanthone, 1-[2-(2-(meth)acryloyloxyethoxy)-2-oxoethoxy]thioxanthone, 2-[2-(2-(meth)acryloyloxyethoxy)-2-oxoethoxy]thioxanthone, 3-[2-(2-(meth)acryloyloxyethoxy)-2-oxoethoxy]thioxanthone, 4-[2-(2-(meth)acryloyloxyethoxy)-2-oxoethoxy]thioxanthone, 1-[2-(3-(meth)acryloyloxypropyloxy)-2-oxoethoxy]thioxanthone, 2-[2-(3-(meth)acryloyloxypropyloxy)-2-oxoethoxy]thioxanthone, 3-[2-(3-(meth)acryloyloxypropyloxy)-2-oxoethoxy]thioxanthone, 4-[2-(3-(meth)acryloyloxypropyloxy)-2-oxoethoxy]thioxanthone, 1-[2-(4-(meth)acryloyloxybutoxy)-2-oxoethoxy]thioxanthone, 2-[2-(4-(meth)acryloyloxybutoxy)-2-oxoethoxy]thioxanthone, 3-[2-(4-(meth)acryloyloxybutoxy)-2-oxoethoxy]thioxanthone, 4-[2-(4-(meth)acryloyloxybutoxy)-2-oxoethoxy]thioxanthone, 1-[2-(2-hydroxy-3-(meth)acryloyloxypropyloxy)-2-oxoethoxy]thioxanthone, 2-[2-(2-hydroxy-3-(meth)acryloyloxypropyloxy)-2-oxoethoxy]thioxanthone, 3-[2-(2-hydroxy-3-(meth)acryloyloxypropyloxy)-2-oxoethoxy]thioxanthone, 4-[2-(2-hydroxy-3-(meth)acryloyloxypropyloxy)-2-oxoethoxy]thioxanthone, 1-[(2- (meth)acryloyloxyethoxy)carbonyloxy]thioxanthone, 2-[(2-(meth)acryloyloxyethoxy)carbonyloxy]thioxanthone, 3-[(2-(meth)acryloyloxyethoxy)carbonyloxy]thioxanthone, 4-[(2-(meth)acryloyloxyethoxy)carbonyloxy]thioxanthone, 1-[(3-(meth)acryloyloxypropoxy)carbonyloxy]thioxanthone, 2-[(3-(meth)acryloyloxypropoxy)carbonyloxy]thioxanthone, 3-[(3-(meth)acryloyloxypropoxy)carbonyloxy]thioxanthone, 4-[(3-(meth)acryloyloxypropoxy)carbonyloxy]thioxanthone, 1-[(4-(meth)acryloyloxybutoxy)carbonyloxy]thioxanthone, 2-[(4-(meth)acryloyloxybutoxy)carbonyloxy]thioxanthone, 3-[(4-(meth)acryloyloxybutoxy)carbonyloxy]thioxanthone, 4-[(4-(meth)acryloyloxybutoxy)carbonyloxy]thioxanthone, and derivatives thereof. The photoinitiator (b1) may be used alone or in combination of two or more kinds thereof.

In the present disclosure, a contained amount of the above-described photoinitiator (B) is preferably 0.01 parts by mass or more, more preferably 0.05 parts by mass or more, particularly preferably 0.08 parts by mass or more, and still more preferably 0.1 parts by mass or more with respect to 100 parts by mass of the (meth)acrylic polymer (A); and the upper limit thereof is preferably 10 parts by mass or less, more preferably 8 parts by mass or less, still more preferably 5 parts by mass or less, and particularly preferably 3 parts by mass or less. When the contained amount of the photoinitiator (B) is equal to or more than the above-described lower limit value, curing failure tends to be prevented; and when the contained amount of the photoinitiator (B) is equal to or less than the above-described upper limit value, the photoinitiator (B) is prevented from bleeding out, and the problem of embrittlement or coloration tends to be suppressed.

A contained amount of the photoinitiator (b1) in the present adhesive composition is preferably 0.05 parts by mass or more, more preferably 0.1 parts by mass or more, and still more preferably 0.2 parts by mass or more with respect to 100 parts by mass of the (meth)acrylic polymer (A). In addition, the upper limit thereof is preferably 10 parts by mass or less, more preferably 8 parts by mass or less, still more preferably 5 parts by mass or less, and particularly preferably 3 parts by mass or less. When the contained amount of the photoinitiator (b1) is equal to or more than the above-described lower limit value, curing failure tends to be prevented; and when the contained amount of the photoinitiator (b1) is equal to or less than the above-described upper limit value, the photoinitiator (b1) is prevented from bleeding out, and the problem of embrittlement or coloration tends to be suppressed. In addition, when the contained amount of the photoinitiator (b1) is equal to or more than the above-described upper limit value, a residual concentration which is not completely consumed after the light irradiation also increases, which may cause product deterioration due to the progress of an unintended curing reaction in an environment exposed to severe ultraviolet rays. The above-described lower limit and upper limit of the contained amount of the photoinitiator (b1) can be arbitrarily combined. Specifically, the contained amount of the photoinitiator (b1) in the present adhesive composition is preferably 0.05 parts by mass or more and 10 parts by mass or less, more preferably 0.1 parts by mass or more and 8 parts by mass or less, and still more preferably 0.2 parts by mass or more and 5 parts by mass or less with respect to 100 parts by mass of the (meth)acrylic polymer (A).

As long as the effect of the present disclosure is not impaired, the present adhesive composition may contain a photoinitiator (b2) other than the photoinitiator (b1), as the photoinitiator (B). The photoinitiator (b2) is a compound which does not have the radically polymerizable functional group having a carbon-carbon double bond or has the radical generating group in the molecule, and has a molar absorption coefficient of less than 30 (L/mol·cm) at 405 nm. The photoinitiator (b2) may be any of the hydrogen abstraction-type photoinitiator or the cleavage-type photoinitiator, and each of them may be used alone or both of them may be used in combination, and one or two or more kinds thereof may be used in combination.

The hydrogen abstraction-type photoinitiator is roughly classified into an intermolecular hydrogen abstraction-type photoinitiator which abstracts hydrogen from another molecule and an intramolecular hydrogen abstraction-type photoinitiator which also causes the hydrogen abstraction reaction in the same molecule.

Examples of the hydrogen abstraction-type photoinitiator as the above-described photoinitiator (b2) include intermolecular hydrogen abstraction-type photoinitiators such as benzophenone, 4-methylbenzophenone, 2,4,6-trimethylbenzophenone, 4-phenylbenzophenone, 3,3′-dimethyl-4-methoxybenzophenone, methyl 2-benzoylbenzoate, 4-[(4-methylphenyl) thio] benzophenone, 4-acryloyloxybenzophenone, 4-acryloyloxyethoxybenzophenone, 4-acryloyloxy-4′-methoxybenzophenone, 4-acryloyloxyethoxy-4′-methoxybenzophenone, 4-acryloyloxy-4′-bromobenzophenone, 4-acryloyloxyethoxy-4′-bromobenzophenone, 4-methacryloyloxybenzophenone, 4-methacryloyloxyethoxybenzophenone, 4-methacryloyloxy-4′-methoxybenzophenone, 4-methacryloyloxyethoxy-4′-methoxybenzophenone, 4-methacryloyloxy-4′-bromobenzophenone, and 4-methacryloyloxyethoxy-4′-bromobenzophenone; and intramolecular hydrogen abstraction-type photoinitiators such as methyl benzoylformate, oxyphenylacetic acid-2-(2-oxo-2-phenylacetoxy-ethoxy) ethyl ester, and oxyphenylacetic acid-2-(2-hydroxy-ethoxy) ethyl ester.

Among the above, 4-acryloyloxybenzophenone, 4-acryloyloxyethoxybenzophenone, 4-acryloyloxy-4′-methoxybenzophenone, 4-acryloyloxyethoxy-4′-methoxybenzophenone, or the like, which has a radically polymerizable functional group having a carbon-carbon double bond in the molecule, is preferable from the viewpoint that the polymerization structure is incorporated after the photoreaction, thereby suppressing the bleeding out of the photoinitiator and improving the cohesive force of the adhesive sheet.

In addition, an intramolecular hydrogen abstraction-type photoinitiator such as methyl benzoylformate, oxyphenylacetic acid-2-(2-oxo-2-phenylacetoxy-ethoxy) ethyl ester, and oxyphenylacetic acid-2-(2-hydroxy-ethoxy) ethyl ester is preferable from the viewpoint that not only a hydrogen donor in a system but also the photoinitiator itself can be a radical generation site.

In addition, as the photoinitiator (b2), a cleavage-type photoinitiator may also be used to the extent that the photodecomposition product does not affect the quality. The cleavage-type photoinitiator is preferable from the viewpoint of high photosensitivity. Examples of the above-described cleavage-type photopolymerization initiator include 2,2-dimethoxy-1,2-diphenylethan-1-one, 1-hydroxycyclohexylphenylketone, 2-hydroxy-2-methyl-1-phenyl-propan-1-one, 1-[4-(2-hydroxyethoxy) phenyl]-2-hydroxy-2-methyl-1-propan-1-one, 2-hydrodooxy-1-{4-[4-(2-hydroxy-2-methyl-propionyl) benzyl]phenyl}-2-methyl-propan-1-one, oligo (2-hydroxy-2-methyl-1-(4-(1-methylvinyl) phenyl) propanone), 2-benzyl-2-dimethylamino-1-(4-morpholinophenyl) butan-1-one, 2-methyl-1-[4-(methylthio) phenyl]-2-morpholinopropan-1-one, 2-(dimethylamino)-2-[(4-methylphenyl) methyl]-1-[4-(4-morpholinyl)phenyl]-1-butanone, bis (2,4,6-trimethylbenzoyl)-phenylphosphine oxide, 2,4,6-trimethylbenzoyldiphenylphosphine oxide, (2,4,6-trimethylbenzoyl)ethoxyphenylphosphine oxide, bis(2,6-dimethoxybenzoyl) 2,4,4-trimethylpentylphosphine oxide, 1-[4-(phenylthio)phenyl]-1,2-octanedione 2-(O-benzoyloxime), 1-(O-acetyloxime)-1-[9-ethyl-6-(2-methylbenzoyl)-9H-carbazol-3-yl]ethanone, 1-[4-[[4-(2-hydroxyethoxy) phenyl]thio]phenyl]-1,2-propanedione 2-(O-acetyloxime), 1-[1-(4-benzoylphenyl)-1H-indol-3-yl]-1,2-octanedione 2-(O-acetyloxime), and derivatives thereof.

A contained amount of the photoinitiator (b2) in the present adhesive composition is preferably 5 parts by mass or less, more preferably 4 parts by mass or less, still more preferably 3 parts by mass or less, and particularly preferably 2 parts by mass or less with respect to 100 parts by mass of the (meth)acrylic polymer (A). The lower limit value thereof is usually 0 parts by mass. Specifically, the contained amount of the photoinitiator (b2) in the present adhesive composition is preferably 0 parts by mass or more and 5 parts by mass or less, more preferably 0.1 parts by mass or more and 4 parts by mass or less, still more preferably 0.5 parts by mass or more and 3 parts by mass or less, and particularly preferably 1 part by mass or more and 2 parts by mass or less with respect to 100 parts by mass of the (meth)acrylic polymer (A).

In addition, in the present disclosure, from the viewpoint of obtaining the effect of the present disclosure, the contained amount of the photoinitiator (b1) in the photoinitiator (B) is preferably 30% by mass or more, more preferably 50% by mass or more, and still more preferably 70% by mass or more with respect to the total mass of the photoinitiator (B). Furthermore, in the photoinitiator (B), it is preferable that the entire amount of the photoinitiator (B) is the photoinitiator (b1).

### <Polyfunctional (Meth)acrylate (C)>

From the viewpoint of promoting the crosslinking reaction, the present adhesive composition preferably contains a polyfunctional (meth)acrylate (C). As a result, for example, even with the same light irradiation amount, the present adhesive composition can quickly form the crosslinked structure. In addition, when the crosslinked structure is formed in an adhesive sheet formed of the present adhesive composition, it is possible to prevent adhesive overflow during storage or when being wound in a roll, and it is possible to obtain favorable adhesiveness and favorable cohesive force.

However, when the acrylic polymer (A) undergoes the hydrogen abstraction reaction by the action of the photoinitiator (B) or the like to form a sufficient crosslinked structure in the acrylic polymer (A) and between the acrylic polymers (A), it is not necessary to contain the polyfunctional (meth)acrylate (C).

Examples of the polyfunctional (meth)acrylate (C) include a (meth)acrylic monomer and a (meth)acrylic oligomer, each of which has two or more functional groups. These can be used alone or in combination of two or more kinds thereof.

Examples of the (meth)acrylic monomer having two or more functional groups include pentanediol di (meth)acrylate, hexanediol di (meth)acrylate, heptanediol di(meth)acrylate, octanediol di(meth)acrylate, nonanediol di(meth)acrylate, decanediol di(meth)acrylate, undecandiol di(meth)acrylate, dodecanediol di(meth)acrylate, 1,4-butanediol di(meth)acrylate, glycerol di(meth)acrylate, neopentyl glycol di(meth)acrylate, glycerol glycidyl ether di(meth)acrylate, tricyclodecane dimethacrylate, tricyclodecanedimethanol di(meth)acrylate, bisphenol A polyethoxydi(meth)acrylate, bisphenol A polypropoxydi(meth)acrylate, bisphenol F polyethoxydi(meth)acrylate, ethylene glycol di(meth)acrylate, neopentyl glycol di(meth)acrylate, trimethylolpropane trioxethyl (meth)acrylate, ϵ-caprolactone-modified tris(2-hydroxyethyl)isocyanurate tri(meth)acrylate, pentaerythritol tri(meth)acrylate, propoxylated pentaerythritol tri(meth)acrylate, ethoxylated pentaerythritol tri(meth)acrylate, pentaerythritol tetra(meth)acrylate, propoxylated pentaerythritol tetra(meth)acrylate, ethoxylated pentaerythritol tetra(meth)acrylate, dipentaerythritol hexa(meth)acrylate, polyethylene glycol di(meth)acrylate, polypropylene glycol di(meth)acrylate, polytetramethylene glycol di(meth)acrylate, tris(acryloxyethyl)isocyanurate, dipentaerythritol hexa(meth)acrylate, dipentaerythritol penta(meth)acrylate, tripentaerythritol hexa(meth)acrylate, tripentaerythritol penta(meth)acrylate, hydroxydivaleryl neopentyl glycol di(meth)acrylate, di(meth)acrylate of a ϵ-caprolactone adduct of hydroxydivaleryl neopentyl glycol, trimethylolpropane tri(meth)acrylate, trimethylolpropane polyethoxy tri(meth)acrylate, and ditrimethylolpropane tetra(meth)acrylate.

Examples of the polyfunctional (meth)acrylic oligomer include polyfunctional (meth)acrylic oligomers such as a polyester (meth)acrylate-based oligomer, an epoxy (meth)acrylate-based oligomer, a urethane (meth)acrylate-based oligomer, and a polyether (meth)acrylate-based oligomer.

Among the above, from the viewpoint of imparting appropriate flexibility to the cured product, (meth)acrylate-based monomer and oligomer having a glycol structure are preferable.

From the viewpoint of imparting shape stability of the adhesive sheet and durability when used for a laminate for an image display device, a contained amount of the polyfunctional (meth)acrylate (C) in the present adhesive composition is preferably 0.1 parts by mass or more, more preferably 0.5 parts by mass or more, and still more preferably 1 part by mass or more with respect to 100 parts by mass of the (meth)acrylic polymer (A). In addition, from the viewpoint of maintaining the flexibility of the adhesive sheet, the upper limit thereof is preferably 20 parts by mass or less, more preferably 15 parts by mass or less, still more preferably 12 parts by mass or less, and particularly preferably 10 parts by mass or less.

The lower limit and upper limit of the above-described contained amount of the polyfunctional (meth)acrylate (C) can be arbitrarily combined. The contained amount of the polyfunctional (meth)acrylate (C) in the present adhesive composition is preferably 0.1 parts by mass or more and 20 parts by mass or less, more preferably 0.5 parts by mass or more and 15 parts by mass or less, still more preferably 1 part by mass or more and 12 parts by mass or less, and particularly preferably 1 part by mass or more and 10 parts by mass or less with respect to 100 parts by mass of the (meth)acrylic polymer (A).

In addition, from the viewpoint of further improving the crosslinking density and improving long-term reliability, a thermal crosslinking agent can also be used in combination with the polyfunctional (meth)acrylate (C).

Examples of such a thermal crosslinking agent include an isocyanate-based crosslinking agent, an epoxy-based crosslinking agent, an aziridine-based crosslinking agent, a melamine-based crosslinking agent, an aldehyde-based crosslinking agent, an amine-based crosslinking agent, and a metal chelate-based crosslinking agent. Among the above, an isocyanate-based crosslinking agent is preferably used from the viewpoint that reactivity with the (meth)acrylic polymer (A) is excellent.

### <Other Components>

The present adhesive composition can appropriately contain, as necessary, various additives, such as a silane coupling agent, a plasticizer, a viscosity imparting resin, an antioxidant, a light stabilizer, a metal inactivator, an anti-aging agent, a moisture absorbent, an anticorrosive agent, an ultraviolet absorber, and inorganic particles as “other components,” as long as the effect of the present disclosure is not impaired.

In addition, a reaction catalyst such as a tertiary amine-based compound, a quaternary ammonium-based compound, and a tin laurate compound may be appropriately contained, as necessary.

These can be used alone or in combination of two or more kinds thereof.

### [Silane Coupling Agent]

The silane coupling agent is an organic silicon compound containing one or more reactive functional groups and one or more alkoxy groups bonded to a silicon atom in the structure. Examples of the above-described reactive functional group include an epoxy group, a (meth)acryloyl group, a mercapto group, a hydroxyl group, a carboxy group, an amino group, an amide group, and an isocyanate group; and among these, an epoxy group or a mercapto group is preferable from the viewpoint of balance of durability.

The above-described alkoxy group bonded to a silicon atom preferably contains an alkoxy group having 1 to 8 carbon atoms and is particularly preferably a methoxy group or an ethoxy group from the viewpoint of durability and storage stability. The silane coupling agent may have an organic substituent other than the reactive functional group and the alkoxy group bonded to a silicon atom, for example, an alkyl group, a phenyl group, or the like.

Examples of the silane coupling agent used in the present disclosure include a monomer-type epoxy group-containing silane coupling agent which is a silane compound, such as 3-glycidoxypropyltrimethoxysilane, 3-glycidoxypropyltriethoxysilane, 3-glycidoxypropylmethyldiethoxysilane, 3-glycidoxypropylmethyldimethoxysilane, and 2-(3,4-epoxycyclohexyl)ethyltrimethoxysilane; an oligomer-type epoxy group-containing silane coupling agent in which a part of the silane compound is hydrolyzed and condensed or the silane compound is co-condensed with an alkyl group-containing silane compound, such as methyltriethoxysilane, ethyltriethoxysilane, methyltrimethoxysilane, and ethyltrimethoxysilane; a monomer-type mercapto group-containing silane coupling agent which is a silane compound, such as 3-mercaptopropyltrimethoxysilane, 3-mercaptopropyltriethoxysilane, γ-mercaptopropyldimethoxymethylsilane, and 3-mercaptopropylmethyldimethoxysilane; an oligomer-type mercapto group-containing silane coupling agent in which a part of the silane compound is hydrolyzed and condensed or the silane compound is co-condensed with an alkyl group-containing silane compound, such as methyltriethoxysilane, ethyltriethoxysilane, methyltrimethoxysilane, and ethyltrimethoxysilane; a (meth)acryloyl group-containing silane coupling agent such as 3-acryloxypropyltrimethoxysilane, 3-methacryloxypropyltrimethoxysilane, 3-methacryloxypropylmethyldiethoxysilane, 3-methacryloxypropyltriethoxysilane, and 3-acryloxypropyltrimethoxysilane; an amino group-containing silane coupling agent such as N-2-(aminoethyl)-3-aminopropylmethyldimethoxysilane, N-2-(aminoethyl)-3-aminopropyltrimethoxysilane, 3-aminopropyltrimethoxysilane, 3-aminopropyltriethoxysilane, 3-triethoxysilyl-N-(1,3-dimethyl-butylidene) propylamine, and N-phenyl-3-aminopropyltrimethoxysilane; an isocyanate group-containing silane coupling agent such as 3-isocyanatopropyltriethoxysilane; and a vinyl group-containing silane coupling agent such as vinyltrimethoxysilane and vinyltriethoxysilane.

These may be used alone or in combination of two or more kinds thereof. Among the above, from the viewpoint of excellent durability, an epoxy group-containing silane coupling agent or a mercapto group-containing silane coupling agent is preferably used, and among these, an epoxy group-containing silane coupling agent is particularly preferable.

A contained amount of the silane coupling agent in the present adhesive composition is preferably 0.005 to 10 parts by mass, more preferably 0.01 to 5 parts by mass, and particularly preferably 0.05 to 1 part by mass with respect to 100 parts by mass of the (meth)acrylic polymer (A). When the contained amount is equal to or more than the above-described lower limit value, the durability tends to be improved; and when the contained amount is equal to or less than the above-described upper limit value, the durability tends to be improved.

### [Plasticizer]

The present adhesive composition can contain a plasticizer in order to impart flexibility to the adhesive sheet.

Examples of the plasticizer are not limited. Examples thereof include compounds selected from the group consisting of polyisobutylene, polyisoprene, polybutadiene, an amorphous polyolefin and a copolymer thereof, silicone, polyacrylate, oligomeric polyurethane, an ethylene propylene copolymer, and any combination or mixture thereof.

Among the above, the plasticizer is preferably polyisobutylene. Examples of the polyisobutylene plasticizer which can be used in the present specification include those commercially available from BASF under the trade name OPPANOL, in particular, those selected from OPPANOL B series.

From the viewpoint of environmental protection, a volatile organic compound (VOC) value of the plasticizer to be used is preferably smaller, and when measured by thermogravimetric analysis, it is preferably less than 1,000 ppm, more preferably less than 800 ppm, still more preferably less than 600 ppm, and most preferably less than 400 ppm.

A contained amount of the plasticizer in the present adhesive composition is not particularly limited, but is preferably 0.1 to 20 parts by mass and more preferably 0.5 to 15 parts by mass or less with respect to 100 parts by mass of the (meth)acrylic polymer (A)

### [Viscosity Imparting Agent]

The present adhesive composition can contain a viscosity imparting agent in order to improve adhesive force to the adhesive sheet.

Examples of the viscosity imparting agent include terpene resins such as polyterpene (for example, an α-pinene-based resin, a β-pinene-based resin, and a limonene-based resin) and an aromatic modified polyterpene resin (for example, a phenol-modified terpene resin); petroleum-based resins such as a coumaran-indene resin, a C5-based hydrocarbon resin, a C9-based hydrocarbon resin, a C5/C9-based hydrocarbon resin, and a dicyclopentadiene-based resin; and rosins such as modified rosin, hydrogenated rosin, polymerized rosin, and rosin ester.

A contained amount of the viscosity imparting agent in the present adhesive composition is not particularly limited, but is preferably 0.1 to 20 parts by mass and more preferably 0.5 to 15 parts by mass or less with respect to 100 parts by mass of the (meth)acrylic polymer (A).

### [Anticorrosive Agent]

The present adhesive composition can contain an anticorrosive agent in order to prevent corrosion when the adherend includes a portion having corrosiveness, such as a metal wire.

Examples of the anticorrosive agent include triazoles and benzotriazoles.

A contained amount of the anticorrosive agent in the present adhesive composition is preferably 0.01 to 5 parts by mass and more preferably 0.1 to 3 parts by mass or less with respect to 100 parts by mass of the (meth)acrylic polymer (A).

### [Ultraviolet Absorber]

The present adhesive composition may contain an ultraviolet absorber. By containing the ultraviolet absorber, deterioration of the adhesive sheet itself or the adherend due to ultraviolet rays can be suppressed.

When the present adhesive composition contains the ultraviolet absorber, in photocuring, it is preferable to cure the composition with rays having a wavelength other than an absorption wavelength of the ultraviolet absorber.

Examples of the ultraviolet absorber include a benzophenone-based ultraviolet absorber, a benzotriazole-based ultraviolet absorber, a triazine-based ultraviolet absorber, a salicylic acid-based ultraviolet absorber, and a cyanoacrylate-based ultraviolet absorber. These ultraviolet absorbers can be used alone or in combination of two or more kinds thereof.

Examples of the above-described benzophenone-based ultraviolet absorber include 2,4-dihydroxybenzophenone, 2-hydroxy-4-methoxybenzophenone, 2-hydroxy-4-octoxybenzophenone, 2-hydroxy-4-benzyloxybenzophenone, 2-hydroxy-4-methoxy-5-sulfoxybenzophenone, 2-hydroxy-4-methoxy-5-sulfoxytrihydridelate benzophenone, 2,2′-dihydroxy-4-methoxybenzophenone, 2,2′,4,4′-tetrahydroxybenzophenone, 2,2′-dihydroxy-4,4′-dimethoxybenzophenone, 2,2′-dihydroxy-4,4′-dimethoxy-5-sodium sulfoxybenzophenone, bis(5-benzoyl-4-hydroxy-2-methoxyphenyl)methane, 2-hydroxy-4-n-dodecyloxybenzophenone, and 2-hydroxy-4-methoxy-2′-carboxybenzophenone.

Examples of the above-described benzotriazole-based ultraviolet absorber include 2-(2-hydroxy-5-methylphenyl)benzotriazole, 2-(2-hydroxy-5-tert-octylphenyl)benzotriazole, 2-(2-hydroxy-3,5-dicumylphenyl)phenylbenzotriazole, 2-(2-hydroxy-3-tert-butyl-5-methylphenyl)-5-chlorobenzotriazole, 2,2′-methylene bis[4-(1,1,3,3-tetramethylbutyl)-6-(2H-benzotriazole-2-yl)phenol], 2-(2-hydroxy-3,5-di-tert-butylphenyl)benzotriazole, 2-(2-hydroxy-3,5-di-tert-butylphenyl)-5-chlorobenzotriazole, 2-(2-hydroxy-3,5-di-tert-amylphenyl)benzotriazole, 2-(2-hydroxy-5-tert-octylphenyl)benzotriazole, 2-(2-hydroxy-5-tert-butylphenyl)benzotriazole, 2-(2-hydroxy-4-octoxyphenyl)benzotriazole, 2,2′-methylene bis (4-cumyl-6-benzotriazole phenyl), and 2,2′-p-phenylene bis(1,3-benzoxazine-4-one), 2-[2-hydroxy-3-(3,4,5,6-tetrahydrophthalimidomethyl)-5-methylphenyl]benzotriazole.

Examples of the above-described triazine-based ultraviolet absorber include 2-(2-hydroxy-4-methoxyphenyl)-4,6-diphenyl-1,3,5-triazine, 2-(2-hydroxy-4-ethoxyphenyl)-4,6-diphenyl-1,3,5-triazine, 2-(2-hydroxy-4-propoxyphenyl)-4,6-diphenyl-1,3,5-triazine, 2-(2-hydroxy-4-butoxyphenyl)-4,6-diphenyl-1,3,5-triazine, 2-(2-hydroxy-4-hexyloxyphenyl)-4,6-diphenyl-1,3,5-triazine, 2-(2-hydroxy-4-octyloxyphenyl)-4,6-diphenyl-1,3,5-triazine, 2-(2-hydroxy-4-dodecyloxyphenyl)-4,6-diphenyl-1,3,5-triazine, 2-(2-hydroxy-4-benzyloxyphenyl)-4,6-diphenyl-1,3,5-triazine, 2,4-bis (2-hydroxy-4-butoxyphenyl)-6-(2,4-dibutoxyphenyl)-1,3-5-triazine, 2,4,6-tris (2-hydroxy-4-hexyloxy-3-methylphenyl)-1,3,5-triazine, 2-(2-hydroxy-4-[1-octyloxycarbonylethoxy]phenyl)-4,6-bis (4-phenylphenyl)-1,3,5-triazine, 2-[4-[(2-hydroxy-3-dodecyloxypropyl)oxy]-2-hydroxyphenyl]-4,6-bis (2,4-dimethylphenyl)-1,3,5-triazine, 2-[4-[(2-hydroxy-3-tridecyloxypropyl)oxy]-2-hydroxyphenyl]-4,6-bis (2,4-dimethylphenyl)-1,3,5-triazine, 2-[4-[(2-hydroxy-3-(2′-ethyl)hexyl)oxy]-2-hydroxyphenyl]-4,6-bis (2,4-dimethylphenyl)-1,3,5-triazine, 2,4-bis (2,4-dimethylphenyl)-6-[2-hydroxy-4-(3-octyloxy-2-hydroxypropyloxy)-5-α-cumylphenyl]-s-triazine, 2,4-bis (2,4-dimethylphenyl)-6-[2-hydroxy-4-(3-nonyloxy-2-hydroxypropyloxy)-5-α-cumylphenyl]-s-triazine, 2,4-bis (2,4-dimethylphenyl)-6-[2-hydroxy-4-(3-decyloxy-2-hydroxypropyloxy)-5-α-cumylphenyl]-s-triazine, and 2-(2-hydroxy-4-acryloyloxyethoxyphenyl)-4,6-bis (2,4-dimethylphenyl)-1,3,5-triazine.

Examples of the above-described salicylic acid-based ultraviolet absorber include phenyl salicylate, p-tert-butylphenyl salicylate, and p-octylphenyl salicylate.

Examples of the above-described cyanoacrylate-based ultraviolet absorber include 2-ethylhexyl-2-cyano-3,3′-diphenyl acrylate and ethyl-2-cyano-3,3′-diphenyl acrylate.

Among the above, from the viewpoint of effectively suppressing the deterioration of the adhesive sheet itself of the adherend due to ultraviolet rays, a benzophenone-based ultraviolet absorber, a benzotriazole-based ultraviolet absorber, or a triazine-based ultraviolet absorber is preferable. Among the above, from the viewpoint of excellent heat resistance, a triazine-based ultraviolet absorber having a triazine structure is more preferable.

From the viewpoint of improving light fast reliability, a contained amount of the ultraviolet absorber in the present adhesive composition is preferably 0.1 parts by mass or more, more preferably 0.5 parts by mass or more, still more preferably 1.5 parts by mass or more, particularly preferably 3 parts by mass or more, and most preferably 5 parts by mass or more with respect to 100 parts by mass of the (meth)acrylic polymer (A). On the other hand, from the viewpoint of suppressing the bleed-out and improving yellowing resistance, the contained amount of the ultraviolet absorber is preferably 15 parts by mass or less, more preferably 12 parts by mass or less, still more preferably 10 parts by mass or less, particularly preferably 8 parts by mass or less, and most preferably 7 parts by mass or less with respect to 100 parts by mass of the (meth)acrylic polymer (A).

A method of preparing the present adhesive composition is not particularly limited. For example, the present adhesive composition is prepared by mixing predetermined amounts of the (meth)acrylic polymer (A), the photoinitiator (b1), and, as necessary, the photoinitiator (b2), the polyfunctional (meth)acrylate (C), and other components such as the silane coupling agent.

The adhesive composition thus obtained is suitably used for an adhesive sheet, particularly an adhesive sheet used for bonding an optical member.

The present adhesive composition may be syrup. A syrup component at this time may be composed of an acrylic polymer and a monomer component. In an example, such a syrup component may be formed by so-called partial polymerization, or may be prepared by adding a monomer to a polymer in which a monomer constituting the (meth)acrylic polymer (A) is completely polymerized or partially polymerized. That is, when a predetermined monomer composition is partially polymerized, some of the monomers are polymerized to form an oligomer or a polymer, and some of the monomers remain, whereby the syrup component can be formed. In addition, in another example, the composition can also be made syrupy by adding a monomer component to the partially polymerized or fully polymerized polymer.

Therefore, the monomer unit constituting the (meth)acrylic polymer (A) in the present specification may refer to a monomer which is present in a state in which an oligomer or a polymer is formed in the components of the acrylic polymer, or a monomer which is contained in the syrup component before polymerization.

### «Adhesive Sheet»

An adhesive sheet for bonding an optical member according to the embodiment of the present disclosure (hereinafter, also referred to as “present adhesive sheet”) is an adhesive sheet having an adhesive layer formed of the present adhesive composition. The present adhesive sheet is particularly useful as an adhesive sheet for an organic EL display device.

The present adhesive sheet may be a monolayer sheet consisting of only an adhesive layer (hereinafter, also referred to as “present adhesive layer”) formed of the present adhesive composition, or may be a multilayer sheet in which a plurality of the present adhesive layers are laminated.

### <Physical Properties of Present Adhesive Sheet>

The present adhesive sheet can have the following physical properties.

### [Gel Fraction (X0)]

A gel fraction (X0) of the present adhesive sheet is preferably 20% or more. When the gel fraction of the present adhesive sheet is equal to or more than the lower limit value, the shape can be easily maintained. From such a viewpoint, the above-described gel fraction (X0) is more preferably 25% or more, still more preferably 30% or more, and particularly preferably 35% or more.

In addition, from the viewpoint of obtaining flexibility, the gel fraction (X0) of the present adhesive sheet is preferably 70% or less, more preferably 60% or less, still more preferably 55% or less, and particularly preferably 50% or less.

The above-described lower limit and upper limit of the above-described gel fraction (X0) can be arbitrarily combined. Specifically, the gel fraction (X0) of the present adhesive sheet is preferably 20% or more and 70% or less, more preferably 25% or more and 60% or less, still more preferably 30% or more and 55% or less, and particularly preferably 35% or more and 50% or less.

The above-described gel fraction (X0) is a guideline for the degree of crosslinking (curing degree), and can be measured under measurement conditions described in Examples later.

The present adhesive sheet preferably has active energy ray curability. Here, the “adhesive sheet has active energy ray curability” means that the adhesive sheet has a property of being cured by active energy ray and, in other words, that the adhesive sheet has room to be cured by active energy ray.

The present adhesive sheet may be an adhesive sheet which has been cured (hereinafter, also referred to as “primary cured”) in a state in which the present adhesive composition is left to be cured with active energy ray, or an adhesive sheet in which the present adhesive composition is crosslinked (primary cured) by a thermal crosslinking agent and can be cured with active energy ray. The primary-cured adhesive sheet can be cured by irradiating active energy ray before or after being bonded to an adherend (hereinafter, also referred to as “secondary cured”)

When the present adhesive sheet has active energy ray curability, the “gel fraction XO” means a gel fraction of the adhesive sheet in a state of being subjected to primary curing.

When the present adhesive sheet is subjected to the primary curing, the primary curing may be carried out by heat or by active energy ray, but from the viewpoint of easily controlling the gel fraction (X0) within the predetermined range, an adhesive sheet which has been subjected to the primary curing by irradiation with active energy ray is preferable.

The active energy ray used for the primary curing is preferably an active energy ray having a wavelength longer than 380 nm, and more preferably an active energy ray having a wavelength longer than 400 nm.

When the present adhesive sheet is subjected to the primary curing with active energy ray, for example, the primary curing is preferably carried out by irradiation with an active energy ray at 405 nm with an integrated irradiation amount of 10 to 4,000 mJ/cm². In such active energy ray irradiation, the irradiation amount is preferably 50 mJ/cm² or more and 3,500 mJ/cm² or less, more preferably 100 mJ/cm² or more and 3,000 mJ/cm² or less, particularly preferably 200 mJ/cm² or more and 2,500 mJ/cm² or less, and even more preferably 300 mJ/cm² or more and 2000 mJ/cm² or less. When the irradiation amount is within the above-described range, the curing degree can be adjusted while leaving room for curing, which is preferable.

The above-described active energy ray irradiation amount is a total of integrated energy on one side and integrated energy on the other side when the active energy ray is irradiated from both sides.

### [Gel Fraction (X1)]

When the present adhesive sheet has active energy ray curability, a gel fraction (X1) of irradiating the adhesive sheet with an active energy ray having a wavelength of 405 nm such that an irradiation amount is within an integrated light amount of 2,000 to 4,000 mJ/cm² (after the secondary curing) is preferably 30% or more, more preferably 40% or more, still more preferably 50% or more, and particularly preferably 60% or more. Specifically, the gel fraction (X1) is preferably 30% or more and 100% or less, more preferably 40% or more and 90% or less, still more preferably 50% or more and 80% or less, and particularly preferably 60% or more and 70% or less. When the gel fraction (X1) after the secondary curing is 30% or more, a laminate for an image display device, using the present adhesive sheet, has excellent durability.

In addition, a difference (X1-X0) between the above-described gel fraction (X1) after the secondary curing and the above-described gel fraction (X0) in a state before the active energy ray irradiation (before the secondary curing), that is, in the primary curing state, is preferably 10% or more, more preferably 15% or more, and still more preferably 20% or more. Specifically, the difference (X1−X0) is preferably 10% or more and 50% or less, more preferably 15% or more and 45% or less, and still more preferably 20% or more and 40% or less. When the difference (X1−X0) is 10% or more, it is possible to achieve both the adhesiveness to the member when the present adhesive sheet is bonded to the image display device constituent member and the durability of the laminate for an image display device after bonding at a higher level.

The above-described gel fraction (X1) can be measured by a method described in Examples later.

### [Adhesive Force]

When the present adhesive sheet has an active energy ray curability, an adhesive force at a peeling angle of 180° and a peeling rate of 60 mm/min with respect to soda lime glass when the adhesive sheet is bonded to soda lime glass and then the soda lime glass is irradiated with an active energy ray having a wavelength of 405 nm with an irradiation amount within an integrated light amount of 2,000 to 4,000 mJ/cm² is preferably 5.0 N/cm or more, more preferably 6.0 N/cm or more, and still more preferably 7.0 N/cm or more. Specifically, the above-described adhesive force is preferably 5.0 N/cm or more and 10.0 N/cm or less, more preferably 6.0 N/cm or more and 9.0 N/cm or less, and still more preferably 7.0 N/cm or more and 8.0 N/cm or less. When the adhesive force is 5.0 N/cm or more, a laminate for an image display device, using the present adhesive sheet, has excellent durability.

In the measurement of the above-described adhesive force, it is preferable that a peeling mode when the present adhesive sheet is peeled off from the member sheet is an interfacial peeling.

Many of image display device constituent members used in an image display device are expensive, and when a defect occurs in the member bonding step, reworkability is required in which the member can be peeled off without leaving glue.

Specifically, it is necessary to prevent the occurrence of so-called “tear-off” in which the adhesive sheet remains on the surface of the member when the image display device constituent member is peeled off. When the peeling mode is interfacial peeling, an adhesive sheet having excellent reworkability, which does not contaminate a product, is obtained.

The peeling mode of the adhesive sheet can be determined, for example, by visually observing the adherend after the adhesive force measurement test and confirming the presence or absence of glue residue. More specifically, a case where the residue of the adhesive is at a level that can be visually confirmed can be determined as cohesive failure.

### [Chromaticity]

A chromaticity (b*) of the present adhesive sheet is preferably 4.0 or less, more preferably 3.0 or less, still more preferably 2.5 or less, particularly preferably 2.0 or less, especially preferably 1.5 or less, and most preferably 1.0 or less. Specifically, the chromaticity (b*) is preferably 0 or more and 4.0 or less, more preferably 0 or more and 3.0 or less, still more preferably 0.1 or more and 2.5 or less, particularly preferably 0.3 or more and 2.0 or less, especially preferably 0.5 or more and 1.5 or less, and most preferably 0.8 or more and 1.0 or less.

The present adhesive sheet has transparency in visual observation, and the transparency indicates that the respective components are uniformly compatible with each other. When the present adhesive sheet is transparent, an excellent appearance can be obtained without impairing visibility of an image display surface. The transparency in visual observation specifically means that, with regard to the present adhesive sheet, the total light transmittance measured in accordance with JIS K 7361-1 (ISO-13468-1) is 50% or more, and the haze value measured in accordance with JIS K 7136 (ISO-14782) is 10% or less.

### [Total Light Transmittance and Haze]

The total light transmittance of the present adhesive sheet, measured in accordance with JIS K 7361-1 (ISO-13468-1), is preferably 80% or more, more preferably 85% or more, and still more preferably 90% or more. Specifically, the total light transmittance is preferably 80% or more and 100% or less, more preferably 85% or more and 100% or less, and still more preferably 90% or more and 100% or less. When the total light transmittance of the present adhesive sheet is equal to or more than the above-described lower limit value, the present adhesive sheet can be suitably used as an adhesive sheet for an image display device.

The haze of the present adhesive sheet, measured in accordance with JIS K 7136 (ISO-14782), is preferably 1.0% or less, more preferably 0.8% or less, and still more preferably 0.5% or less. Specifically, the haze is preferably 0% or more and 1.0% or less, more preferably 0% or more and 0.8% or less, and still more preferably 0% or more and 0.5% or less. When the haze of the present adhesive sheet is 1.0% or less, the present adhesive sheet can be suitably used as an adhesive sheet for an image display device.

The above-described haze can be measured with a haze meter.

In order to make the haze of the present adhesive sheet within the above-described range, it is preferable that the present adhesive sheet does not contain particles such as organic particles.

### <Thickness>

A thickness of the present adhesive sheet is not particularly limited, but when the thickness is 10 μm or more, handleability is favorable, and when the thickness is 1,000 μm or less, the present adhesive sheet can be thinner. From such a viewpoint, the thickness of the present adhesive sheet is preferably 10 μm or more, more preferably 15 μm or more, still more preferably 20 μm or more, and particularly preferably 25 μm or more. On the other hand, the upper limit thereof is preferably 1,000 μm or less, more preferably 500 μm or less, still more preferably 400 μm or less, particularly preferably 300 μm or less, and most preferably 250 μm or less. Specifically, the thickness of the adhesive sheet is preferably 10 μm or more and 1000 μm or less, more preferably 15 μm or more and 500 μm or less, still more preferably 20 μm or more and 300 μm or less, and particularly preferably 25 μm or more and 250 μm or less.

### <Method of Manufacturing Present Adhesive Sheet>

Next, a method of manufacturing the present adhesive sheet will be described. However, the following description is an example of the method of manufacturing the present adhesive sheet, and the present adhesive sheet is not limited to those manufactured by such a manufacturing method.

The present adhesive sheet may be manufactured, for example, by preparing the present adhesive composition, molding the present adhesive composition into a sheet shape, curing the present adhesive composition by crosslinking, that is, by polymerization reaction, and appropriately processing the sheet, as necessary. In addition, the present adhesive sheet may be formed by preparing the present adhesive composition, coating a member for constituting an image display device with the present adhesive composition, and curing the present adhesive composition.

When preparing the present adhesive composition, the above-described raw materials may be mixed using a propeller type stirrer or a kneader (for example, a uniaxial extruder, a biaxial extruder, a planetary mixer, a biaxial mixer, a pressurized kneader, or the like).

When mixing various raw materials, various additives such as a silane coupling agent and an antioxidant may be supplied to the stirrer or the kneader after being blended with a resin in advance, all materials may be supplied after being melted and mixed in advance, or a master batch in which only the additives are concentrated in a resin in advance may be prepared and supplied.

As a method of molding the present adhesive composition into a sheet shape, a known method, for example, a wet lamination method, a dry lamination method, an extrusion casting method using a T-die, an extrusion lamination method, a calender method, an inflation method, injection molding, a liquid injection curing method, or the like can be adopted. Among the above, when manufacturing a sheet, a wet lamination method, an extrusion casting method, or an extrusion lamination method is suitable.

The curing of the present adhesive composition can be carried out by irradiating with active energy ray, and the present adhesive sheet can be manufactured by irradiating a molded body of the present adhesive composition, for example, a molded body formed into a sheet body, with active energy ray. In addition to the irradiation with active energy ray, the adhesive composition can be further cured by heating.

The irradiation energy, the irradiation time, the irradiation method, and the like with active energy ray are not particularly limited, and the monomer component may be polymerized by activating the photopolymerization initiator.

Examples of the active energy ray in the above-described active energy ray irradiation include rays such as far ultraviolet rays, ultraviolet rays, near ultraviolet rays, infrared rays, and visible rays; and ionizing radiation such as X-rays, α-rays, β-rays, γ-rays, electron beams, proton beams, and neutron beams. Among the above, ultraviolet rays or visible rays are suitable from the viewpoint of suppressing damage to the image display device constituent member and easily controlling the reaction. In addition, curing by ultraviolet irradiation or visible light irradiation is advantageous from the viewpoint of curing speed, ease of obtaining an irradiation device, price, and the like. Among the above, from the viewpoint of preventing curing inhibition by the ultraviolet absorber, curing with visible rays, for example, with an active energy ray of 405 nm is preferable.

Examples of a light source for the active energy ray irradiation include a high-pressure mercury lamp, an ultra-high pressure mercury lamp, a low-pressure mercury lamp, a carbon arc lamp, a metal halide lamp, a xenon lamp, a chemical lamp, an inductively coupled plasma lamp, and an LED, each of which emit light in a wavelength range of 150 to 450 nm.

From the viewpoint of curing, an irradiation amount (integrated light amount) of the active energy ray is preferably 10 to 6,000 mJ/cm², more preferably 50 mJ/cm² to 5,500 mJ/cm², still more preferably 100 mJ/cm² to 5,000 mJ/cm², particularly preferably 200 mJ/cm² to 4,000 mJ/cm², and most preferably 300 mJ/cm² to 3,000 mJ/cm².

As another embodiment of the method of manufacturing the present adhesive sheet, the present adhesive sheet can also be manufactured by dissolving the adhesive composition in an appropriate solvent and using various coating methods. When the adhesive composition is syrup, it is also possible to perform coating without using a solvent.

When a coating method is used, the present adhesive sheet can also be obtained by heat-curing in addition to the curing by the above-described active energy ray irradiation. In the coating, the thickness of the present adhesive sheet can be adjusted by a coating thickness and a concentration of solid contents of a coating liquid.

For example, the present adhesive sheet can be formed by dissolving the adhesive composition in a solvent, coating a release film with the coating liquid, drying the coating liquid, and curing the coating liquid with active energy ray. Furthermore, a release film may be laminated, as necessary. In this case, the release film may be coated, dried, and cured by irradiation with active energy ray, and then a release film may be laminated thereon to form the present adhesive sheet, or the release film may be coated, dried, and laminated, and then cured by irradiation with active energy ray to form the present adhesive sheet.

The solvent is not particularly limited as long as the solvent dissolves the present adhesive composition. Examples thereof include ester-based solvents, such as methyl acetate, ethyl acetate, butyl acetate, methyl acetoacetate, and ethyl acetoacetate; ketone-based solvents, such as acetone, methyl ethyl ketone, and methyl isobutyl ketone; aromatic solvents, such as toluene and xylene; and alcohol-based solvents, such as methanol, ethanol, and propyl alcohol. These can be used alone or in combination of two or more kinds thereof. Among the above, ethyl acetate, acetone, methyl ethyl ketone, or toluene is preferable from the viewpoint of solubility, drying properties, price, and the like; and ethyl acetate is particularly suitably used.

From the viewpoint of drying properties, an amount of the solvent used is preferably 600 parts by mass or less, more preferably 500 parts by mass or less, still more preferably 400 parts by mass or less, and particularly preferably 300 parts by mass or less with respect to 100 parts by mass of the (meth)acrylic polymer (A). On the other hand, the amount is preferably 1 part by mass or more, more preferably 50 parts by mass or more, still more preferably 100 parts by mass or more, and particularly preferably 150 parts by mass or more.

The coating method can be a commonly used method such as roll coating, die coating, gravure coating, comma coating, screen printing, and bar coating.

A contained amount of the solvent in the adhesive composition after the above-described drying is preferably 1% by mass or less, more preferably 0.5% by mass or less, particularly preferably 0.1% by mass or less, and most preferably 0% by mass.

A drying temperature is usually 40° C. to 150° C., more preferably 45° C. to 140° C., still more preferably 50° C. to 130° C., and particularly preferably 55° C. to 120° C. In the above-described temperature range, the solvent can be removed efficiently and relatively stably while suppressing thermal deformation of the release film.

A drying time is usually 1 to 30 minutes, more preferably 3 to 25 minutes, and still more preferably 5 to 20 minutes. In the above-described time range, the solvent can be efficiently and sufficiently removed.

Examples of the drying method include drying with a dryer, drying with a heat roll, and drying with hot air blown to the film. Among the above, a dryer is preferable from the viewpoint that the drying can be performed uniformly and easily. These can be used alone or in combination of two or more kinds thereof.

### «Adhesive Sheet With Release Film»

The present adhesive sheet can also be provided as an adhesive sheet with a release film (adhesive sheet laminate) by laminating a release film on one or both surfaces of the adhesive layer consisting of the present adhesive composition (the present adhesive sheet).

When the release film is provided on both surfaces of the present adhesive sheet, it is preferable to adopt a laminate configuration in which a lightly peeling film having a relatively low peeling force and a heavily peeling film having a relatively high peeling force are laminated. When the adhesive sheet with a release film, having release films on both surfaces, is used, first, one release film (lightly peeling film) is peeled off to expose one surface of the adhesive sheet, the adhesive sheet is bonded to an image display device constituent member (referred to as a first member), and the other release film (heavily peeling film) is peeled off to bond the other surface of the exposed adhesive sheet to another image display device constituent member (referred to as a second member).

As such a release film, a known release film can be appropriately used.

As a material of the release film, for example, a peeling-treated product obtained by applying a release agent such as a silicone resin to a film, such as a polyester film, a polyolefin film, a polycarbonate film, a polystyrene film, an acrylic film, a triacetyl cellulose film, and a fluororesin film, or a release paper can be appropriately selected and used. Among the above, a polyester film, specifically, a polyethylene terephthalate (PET) film, particularly a biaxially stretched PET film is preferable from the viewpoint of excellent transparency, mechanical strength, heat resistance, flexibility, and the like. A release film in which a release layer obtained by curing a curable silicone-based release agent containing a silicone resin as a main component is provided on the above- described base material can be used.

A thickness of the release film is not particularly limited. For example, from the viewpoint of workability and handleability, the thickness is preferably 10 to 250 μm, more preferably 25 to 200 μm, and still more preferably 35 to 190 μm.

<Preferred use of present adhesive sheet>The present adhesive sheet is suitably used for bonding an optical member. Specifically, the present adhesive sheet is used as a member constituting a display, in particular, as a member for bonding a member used for producing a display; and is used as an adhesive sheet for bonding an image display panel and an image display device constituent member such as a protective panel and a touch panel, which is disposed on a front surface side (visible side) of the image display panel, or a member constituting the image display device constituent member.

The same components as described below can be used as the image display device constituent member.

### «Laminate for Image Display Device»

A laminate for an image display device according to an example of an embodiment of the present disclosure (hereinafter, also referred to as “present laminate for an image display device”) is a laminate for an image display device, in which two image display device constituent members are laminated through the present adhesive sheet. It is preferable that the present laminate for an image display device has a configuration in which two image display device constituent members are laminated through the present adhesive sheet.

Among the components of the present laminate for an image display device, the present adhesive sheet is as described above, and the components other than the present adhesive sheet will be described below.

### <Image Display Device Constituent Member>

Examples of the image display device constituent member constituting the present laminate for an image display device include a flat panel image display device constituent member and a flexible image display device constituent member. Examples of such an image display device constituent member include a liquid crystal display, a flexible display such as an organic electroluminescence (EL) display, a cover lens (cover film), a polarizing plate, a polarizer, a phase difference film, a barrier film, a viewing angle compensation film, a brightness improvement film, a contrast improvement film, a diffusion film, a semi-transmissive reflective film, an electrode film, a transparent conductive film, a metal mesh film, and a touch sensor film. Any one or two of these may be used in combination. For example, a combination of the flexible display and other image display device constituent members, or a combination of the cover lens and other image display device constituent members can be used.

The flexible image display device constituent member means a member which is a bendable member and used for an image display device having a curved surface shape, or a member which is repeatedly bendable. In particular, it is preferable that the flexible image display device constituent member is a member which can be fixed to a curved shape having a curvature radius of 25 mm or more, and particularly preferably a member which can withstand a bending action with a curvature radius of less than 25 mm, more preferably a curvature radius of less than 3 mm.

In the above-described configuration, examples of the member constituting the image display device constituent member include a resin sheet and glass.

Examples of a material of the resin sheet include a polyester resin, a cycloolefin resin, a triacetyl cellulose resin, a polymethyl methacrylate resin, a polyurethane, an epoxy resin, a polyimide resin, and an aramid resin; and these resins may be used alone or in combination of two or more kinds thereof. Among the above, a resin sheet containing, as a main component, at least one resin selected from the group consisting of a polyester resin, a cycloolefin resin, a triacetyl cellulose resin, a polymethyl methacrylate resin, an epoxy resin, a polyimide resin, an aramid resin, and a polyurethane resin is preferable.

Here, the “main component” refers to a component which occupies the highest weight ratio among the components constituting the image display device constituent member; and specifically, the main component occupies 50% by mass or more of the resin composition (resin sheet) forming the image display device constituent member, and further, it is preferable that the main component occupies 55% by mass or more, particularly 60% by mass or more.

### <Method of Manufacturing Present Laminate for Image Display Device>

The method of manufacturing the present laminate for an image display device is not particularly limited, and for example, as described above, the adhesive composition may be applied onto the image display device constituent member to form an adhesive sheet, or an adhesive sheet with a release film may be formed in advance and then bonded to the image display device constituent member.

### «Image Display Device»

An image display device according to an example of an embodiment of the present disclosure (hereinafter, also referred to as “present image display device”) is an image display device obtained by incorporating the laminate for an image display device, having a configuration in which two image display device constituent members are bonded to each other through the present adhesive sheet. For example, the laminate for an image display device, having a configuration in which two image display device constituent members are bonded to each other through the present adhesive sheet, can be laminated on another image display device constituent member to form the present adhesive sheet image display device including the laminate.

### EXAMPLES

Hereinafter, an example of an embodiment of the present disclosure will be described in detail. However, the present disclosure is not limited to the embodiment described below.

First, details of raw materials of adhesive compositions prepared in Examples will be described.

### <(Meth)acrylic Polymer (A)>

(Meth)acrylic polymer (A-1): acrylic copolymer obtained by random copolymerization of 67 parts by mass of 2-ethylhexyl acrylate, 5 parts by mass of methyl acrylate, 10 parts by mass of ethyl acrylate, 4 parts by mass of 4-hydroxybutyl acrylate, and 14 parts by mass of hydroxyethyl acrylate (weight-average molecular weight: approximately 700,000)

### <Photoinitiator (B)>

Photoinitiator (b1-1): photoinitiator having a radically polymerizable functional group having a carbon-carbon double bond, represented by Formula 2-1, and a thioxanthone structure as a radical generating group in the molecule (molar absorption coefficient at a wavelength of 405 nm: 1.7×10³ L/mol·cm)

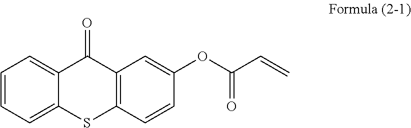 [SMILES: C=CC(=O)Oc1ccc2sc3ccccc3c(=O)c2c1]

Photoinitiator (b1-2): photoinitiator having a radically polymerizable functional group having a carbon-carbon double bond, represented by Formula 2-2, and a thioxanthone structure as a radical generating group in the molecule (molar absorption coefficient at a wavelength of 405 nm: 5.9×10³ L/mol·cm)

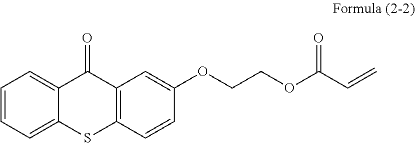 [SMILES: C=CC(=O)OCCOc1ccc2sc3ccccc3c(=O)c2c1]

Photoinitiator (b2-1): 2,4-diethylthioxanthone (“Omnirad DETX” manufactured by IGM Resins; molar absorption coefficient at a wavelength of 405 nm: 3.3×10³ L/mol·cm)
Photoinitiator (b2-2): 4-methacryloyloxybenzophenone (manufactured by

MCC Unitech Co., Ltd., molar absorption coefficient at a wavelength of 405 nm: 0 L/mol·cm)

### Example 1

100 parts by mass of the (meth)acrylic polymer (A-1) and 0.3 parts by mass of the photoinitiator (B1-1) were uniformly mixed to produce an adhesive composition.

The above-described adhesive composition was developed in a sheet shape on a release film (PET film manufactured by Mitsubishi Chemical Corporation) having a thickness of 100 μm, which had been subjected to a silicone release treatment, such that a thickness was 50 μm.

Next, a silicone release-treated release film having a thickness of 75 μm (PET film manufactured by Mitsubishi Chemical Corporation) was laminated on the sheet-like adhesive composition to form a laminate, thereby obtaining an adhesive sheet with a release film, consisting of release film/adhesive sheet/release film.

Next, using a high-pressure mercury lamp, the adhesive sheet was irradiated with light through a UV-cut polyethylene terephthalate film (“O700E100” manufactured by Mitsubishi Chemical Corporation) (light transmittance at a wavelength of 380 nm:

0.7%, light transmittance at a wavelength of 405 nm: 87%) so that the integrated light amount in the vicinity of a wavelength of 405 nm, measured using an ultraviolet ray integrated light meter “UIT-250” (manufactured by Ushio Inc.) and a light receiving device “UVD-C405” (manufactured by Ushio Inc.), was 1,000 mJ/cm² on both surfaces of the adhesive sheet with a release film, and thus the adhesive sheet was semi-cured. The obtained adhesive sheet with a release film included an adhesive sheet having active energy ray curability.

### Examples 2 and 3 and Comparative Examples 1 and 2

An adhesive sheet with a release film was produced in the same manner as in Example 1, except that formulation of the adhesive composition was changed as shown in Table 1.

### [Measurement and Evaluation of Physical Properties]

The adhesive sheets produced in Examples and Comparative Examples were subjected to the following various measurements and evaluations. The evaluation results are summarized in Table 1.

### <Gel Fraction>

From the adhesive sheet with a release film, from which the release film had been peeled off, approximately 0.1 g of an adhesive sheet piece was collected for the adhesive sheet with a release film produced in Examples and Comparative Examples. The collected adhesive sheet piece was wrapped in an SUS mesh (#150) having a mass X (g) in advance in a bag shape, the mouth of the bag was closed to prepare a sample, and a mass Y (g) of the sample was measured. The above-described sample was stored at 23° C. in the dark for 24 hours in a state of being immersed in ethyl acetate, the sample was taken out and heated at 70° C. for 4.5 hours to evaporate ethyl acetate, and a mass Z (g) of the dried sample was measured. From each of the measured masses, a gel fraction (X0) after the primary curing was calculated according to the following expression.

$$Gel fraction ( \% ) = [ ( Z - X ) / ( Y - X ) ] \times 100$$

In addition, the adhesive sheet with a release film, produced in Examples and Comparative Examples, was irradiated with light using a high-pressure mercury lamp through a UV-cut polyethylene terephthalate film (“0700E100” manufactured by Mitsubishi Chemical Corporation) (light transmittance at a wavelength of 380 nm: 0.7%, light transmittance at a wavelength of 405 nm: 87%) so that the integrated amount of light at a wavelength of around 405 nm, measured using an ultraviolet integrated light meter “UIT-250” (manufactured by Ushio Inc.) and a light receiving device “UVD-C405” (manufactured by Ushio Inc.), was 3,000 mJ/cm², thereby curing the adhesive sheet. Using the adhesive sheet after curing, a gel fraction (X1) after the secondary curing was calculated in the same manner as the gel fraction (X0).

### <Chromaticity>

The release film of the adhesive sheet with a release film produced in Examples and Comparative Examples was peeled off, and a bonded sample was prepared by sandwiching the exposed adhesive surfaces with two soda-lime glass plates (thickness: 0.55 mm). For the bonded sample, using a spectrophotometer “SC-T” (Suga Test Instruments Co., Ltd.), a chromaticity (b*) was measured with a D65 light source and a visual field of 10° based on the method of JIS K 7103.

### <Adhesive Force>

One release film of the adhesive sheet with a release film produced in Examples and Comparative Examples was peeled off, and a polyethylene terephthalate film (“COSMOSHINE A4300” manufactured by Toyobo Co., Ltd.) having a thickness of 100 μm was bonded thereto as a backing film to prepare a laminated product.

The above-described laminated product was cut into a length of 150 mm and a width of 10 mm, the remaining release film was peeled off, the exposed adhesive surface was brought into contact with soda-lime glass, and the adhesive sheet was pressure-bonded by a roll reciprocated once. The obtained bonded product was finished and bonded by being left to stand at a temperature of 60° C. for 30 minutes, and then irradiated with light using a high-pressure mercury lamp through a UV-cut polyethylene terephthalate film (“O700E100” manufactured by Mitsubishi Chemical Corporation) (light transmittance at a wavelength of 380 nm: 0.7%, light transmittance at a wavelength of 405 nm: 87%) so that the integrated amount of light at a wavelength of 405 nm, measured using an ultraviolet integrated light meter “UIT-250” (manufactured by Ushio Inc.) and a light receiving device “UVD-C405” (manufactured by Ushio Inc.), was 3,000 mJ/cm2, and the adhesive sheet was cured and left to stand at 23° C. for 15 hours to obtain an adhesive force measurement sample.

A peeling force (N/cm) with respect to glass when the sample for measuring an adhesive force was peeled off at a peeling angle of 180° and a peeling rate of 60 mm/min in an environment of 23° C. and 40% RH was measured, and an adhesive force (P1) was obtained.

The peeling mode when peeling off the adhesive sheet produced in Examples from the glass was interfacial peeling. In addition, those in which the peeling mode was cohesive failure are indicated as “(Cohesive failure)” in the table.

TABLE 1

| | | | | | | Comparative | Comparative |
|---|---|---|---|---|---|---|---|
| | | | Example 1 | Example 2 | Example 3 | Example 1 | Example 2 |
| adhesive | (Meth)acrylic | A-1 | 100 | 100 | 100 | 100 | 100 |
| composition | polymer (A) | | | | | | |
| (part by | Photoinitiator (B) | b1-1 | 0.3 | 0.1 | — | — | — |
| mass) | | b1-2 | — | — | 0.3 | — | — |
| | | b2-1 | — | — | — | 2 | — |
| | | b2-2 | — | — | — | — | 2 |

| | | | | | | |
|---|---|---|---|---|---|---|
| Evaluation | Gel fraction (X0) [%] | 40 | 25 | 10 | 0 | 0 |
| of physical | Gel fraction (X1) [%] | 65 | 47 | 45 | 0 | 0 |
| properties | Difference (X1 − X0) [%] | 25 | 22 | 35 | 0 | 0 |
| | Chromaticity (b*) | 1.5 | 1 | 2.3 | 5.3 | 0.5 |
| | Adhesive force (P1) [N/cm] | 6.6 | 7.5 | 7.4 | 11.5 (Cohesive | 11.9 (Cohesive |
| | | | | | failure) | failure) |

As shown in Table 1, the adhesive sheets of Examples 1 to 3, in which the photoinitiators having the radically polymerizable functional group having a carbon-carbon double bond and the radical group in the molecule and having a molar absorption coefficient of 30 (L/mol cm) or more at a wavelength of 405 nm were used, were suitable in that they had sufficient curability to light having a wavelength of 405 nm and had a low value of chromaticity (b*).

On the other hand, in the adhesive sheet of Comparative Example 1, since the photoinitiator which did not have the radically polymerizable functional group having a carbon-carbon double bond was used, the molar absorption coefficient at a wavelength of 405 nm was sufficiently large, but the adhesive sheet was deteriorated in curability to light having a wavelength of 405 nm.

In addition, in the adhesive sheet of Comparative Example 2, since the photoinitiator having the radically polymerizable functional group having a carbon-carbon double bond and the radical group in the molecule, in which the molar absorption coefficient at a wavelength of 405 nm was 30 (L/mol cm) or less, was used, the molar absorption coefficient at a wavelength of 405 nm was small, and thus the curability to light having a wavelength of 405 nm was deteriorated.

### INDUSTRIAL APPLICABILITY

The adhesive composition according to the embodiment of the present disclosure can be suitably used in an adhesive sheet for bonding an optical member, particularly, an adhesive sheet for an organic EL display device, in which the adhesive composition with a small amount of photodecomposition products can be cured with an energy ray on a relatively long wavelength side (for example, an energy ray having a wavelength of longer than 380 nm, in particular, an active energy ray of 405 nm).

While preferred embodiments of the present disclosure have been described and illustrated above, it should be understood that these are exemplary of the present disclosure and are not to be considered as limiting. Additions, omissions, substitutions, and other modifications can be made without departing from the spirit or scope of the present disclosure. Accordingly, the present disclosure is not to be considered as being limited by the foregoing description, and is only limited by the scope of the appended claims.

1. An adhesive composition the adhesive composition comprising:
a (meth)acrylic polymer; and
a photoinitiator,
wherein the photoinitiator contains a photoinitiator which is a compound having, in a molecule, a radically polymerizable functional group having a carbon-carbon double bond, and a radical generating group, and has a molar absorption coefficient of 30 (L/mol·cm) or more at 405 nm.

2. The adhesive composition according to claim 1,
wherein the photoinitiator includes at least one selected from the group consisting of: a hydrogen abstraction-type photoinitiator having a structure in which the radical generating group is excited by irradiation with an active energy ray to generate a radical through a hydrogen abstraction reaction; and an intramolecular cleavage-type photoinitiator which generates a radical by the excitation of the radical generating group by the irradiation with an active energy ray and subsequent cleavage in the molecule.

3. The adhesive composition according to claim 1,
wherein the photoinitiator comprises a hydrogen abstraction-type photoinitiator in which the radically polymerizable functional group includes a (meth)acryloyl group, the hydrogen abstraction-type photoinitiator having a structure in which the radical generating group is excited by irradiation with an active energy ray to generate a radical through a hydrogen abstraction reaction.

4. The adhesive composition according to claim 1,
wherein the radical generating group in the photoinitiator includes at least one structure selected from the group consisting of a benzoin structure, a benzyl ketal structure, an acylphosphine oxide structure, an α-aminoacetophenone structure, an α-hydroxyacetophenone structure, a benzophenone structure, a thioxanthone structure, an anthraquinone structure, a phenylglyoxylate structure, and an oxime ester structure.

5. The adhesive composition according to claim 1,
wherein the radical generating group in the photoinitiator includes a thioxanthone structure.

6. The adhesive composition according to claim 1,
wherein the adhesive composition includes the photoinitiator in an amount of 0.01 parts by mass or more with respect to 100 parts by mass of the (meth)acrylic polymer.

7. The adhesive composition according to claim 1,
wherein the photoinitiator includes the photoinitiator in an amount of 30% by mass or more with respect to a total mass of the photoinitiator.

8. The adhesive composition according to claim 1,
wherein the (meth)acrylic polymer includes a structural unit derived from an alkyl (meth)acrylate having a linear or branched alkyl group having 3 to 30 carbon atoms in an alkyl group, and at least one structural unit of a structural unit derived from a hydroxyl group-containing monomer or a structural unit derived from a nitrogen-containing monomer.

9. An adhesive sheet comprising:
an adhesive layer formed of the adhesive composition according to claim 1.

10. The adhesive sheet according to claim 9,
wherein a gel fraction (X0) is 20% or more.

11. The adhesive sheet according to claim 10,
wherein the adhesive sheet has active energy ray curability, and a gel fraction (X1) of the adhesive sheet when the adhesive sheet is irradiated with an active energy ray having a wavelength of 405 nm with an irradiation amount within an integrated light amount of 2,000 to 4,000 mJ/cm² is 30% or more.

12. The adhesive sheet according to claim 11,
wherein a difference (X1-X0) between the gel fraction (X1) and the gel fraction (X0) is 10% or more.

13. A method of using the adhesive sheet according to claim 9, comprising bonding an optical member with the adhesive sheet.

14. An adhesive sheet with a release film, comprising:
the adhesive sheet according to claim 9; and
a release film which is laminated with the adhesive sheet.

15. A laminate for an image display device, comprising:
two optical members which are laminated through the adhesive sheet according to claim 9.

16. An image display device comprising:
the laminate for an image display device according to claim 15.

17. An adhesive sheet for an organic Electroluminescent (EL) display device, comprising:
the adhesive sheet according to claim 9.
